(19) United States
(12) Patent Application Publication
(10) Pub. No.: US 2020/0198234 A1
(43) Pub. Date: Jun. 25, 2020

(54) MOVABLE PRINTING DEVICES FOR THREE-DIMENSIONAL PRINTERS

(71) Applicant: Martin Kuster, Walchwil (CH)

(72) Inventor: Martin Kuster, Walchwil (CH)

(21) Appl. No.: 16/077,431

(22) PCT Filed: Feb. 13, 2017
(86) PCT No.: PCT/IB2017/000236

§ 371 Date: Aug. 10, 2018

Related U.S. Application Data
(60) Provisional application No. 62/293,974, filed on Feb. 11, 2016.

(51) Int. Cl. B29C 64/209; B29C 64/112; B29C 64/118; B29C 64/393; B33Y 30/00; B33Y 50/02

(52) U.S. Cl. CPC B29C 64/209; B29C 64/112; B33Y 50/02; B29C 64/393; B33Y 30/00; B29C 64/118

(57) ABSTRACT

A three-dimensional printer includes a printing device and an actuator. The printing device includes an extruder assembly that is movable between a stowed position and a deployed position. In the deployed position, the printing device is configured to print a printing material to generate a three-dimensional model on a build platform.

### REFERENCE TO RELATED APPLICATION

This application claims the benefit of U.S. Provisional Patent Application No. 62/293,974, filed Feb. 11, 2016, and entitled MOVABLE PRINTING DEVICES FOR THREE-DIMENSIONAL PRINTERS, the content of which is incorporated by reference in its entirety.

### TECHNICAL FIELD

The present disclosure relates to three-dimensional printers, and more particularly to movable printing device configurations for a three-dimensional printer.

### BACKGROUND

Three-dimensional printers may be used to generate three-dimensional models. A three-dimensional printer may include one or more extruders having heating nozzles that may soften a material for use in generating the three-dimensional models. The three-dimensional model may be positioned on a build platform near the extruders. The build platform may move as a nozzle of one of the extruders applies the softened material such that the material is manipulated into a desired shape of the three-dimensional model. Each extruder in a three-dimensional printer may be configured to extrude or otherwise apply a material to the three-dimensional model. Similarly, the color of the material in each extruder may vary to allow the three-dimensional model to be generated with multiple colors. But, the use of multiple extruders in a three-dimensional printer may create problems in generating the three-dimensional models or in designing the three-dimensional printer. For example, as the build platform moves the three-dimensional model around the nozzle of the operating extruder, the nozzles of the non-operating extruders may contact the extruder, causing damage to the three-dimensional model. In another example, where it is desirable for a three-dimensional model to have many different colors, additional extruders may be required for each color, resulting in a large and bulky printer to accommodate the number of extruders necessary to apply the desired colors.

### SUMMARY

According to some examples of the disclosure, a three-dimensional printer includes at least two extruder assemblies couplable to a base platform and movable between a stowed position to a deployed position, a first actuator for a first extruder assembly of the at least two extruder assemblies, and a second actuator for a second extruder assembly of the at least two extruder assemblies. The second actuator is configured to retain the second extruder assembly in the stowed position when the first extruder is in the deployed position. The first extruder assembly is configured to print a printing material to generate a three-dimensional model on a build platform while in the deployed position.

According to some examples each of the at least two extruder assemblies includes a nozzle that comprises a heating element configured to heat the printing material prior to applying the printing material to the three-dimensional model. In some examples, the first actuator is configured to move the first extruder assembly into the deployed position in response to the heating of the nozzle with the heating element.

In various examples, the first actuator is configured to move the first extruder assembly toward the build platform from the stowed position in response to the first extruder assembly being selected for use to apply the printing material. In some cases, the first actuator is configured to apply a magnetic force to move the first extruder assembly into the deployed position. In various cases, the first actuator comprises an electric magnet configured to apply the magnetic force to the first extruder assembly. In some examples, the first actuator is configured to apply a mechanical force to move the first extruder assembly into the deployed position. In certain cases, the first actuator comprises an electric motor configured to apply the mechanical force to the first extruder assembly.

In some examples, the three-dimensional printer also includes spring assemblies for each of the at least two extruder assemblies, and the spring assemblies are positionable to retain the at least two extruder assemblies in the stowed position. In certain cases, the spring assemblies comprise a first spring assembly positioned proximate to the first extruder. In various examples, the first spring assembly is configured to apply a force to the first extruder in a stowing direction, and the first actuator is configured to apply an opposing force in a deploying direction that is greater than the force to the first extruder assembly in the stowing direction.

In some cases, the three-dimensional printer also includes a controller communicatively coupled to the first actuator and the second actuator, and the controller comprises a memory device and a processing device, and the memory device comprises instructions executable by the processing device for causing the first actuator to move the first extruder assembly into the deployed position. In various cases, the three-dimensional printer also includes a stopper that defines a movement distance of the first extruder assembly from the stowed position to the deployed position. In various examples, the stopper is adjustable such that the movement distance is a variable distance.

According to some examples of the disclosure, a three-dimensional printer includes at least one extruder assembly, an inkjet printhead assembly including a printhead configured to apply colored ink to a portion of a layer of a three-dimensional model printed on a build platform, and an actuation mechanism configured to move the printhead between a stowed position and a deployed position.

In various cases, the three-dimensional printer also includes the at least one extruder assembly having a nozzle, a heating element, a filament transport casing surrounding a material filament, and a heat isolation component provided between the heating element and the filament transport casing. In certain cases, the three-dimensional printer also includes the at least one extruder assembly having a nozzle and a heating element, a filament transport casing surrounding a material filament, and a liquid cooling system having a flow path through the filament transport casing.

According to some examples of the disclosure, a three-dimensional printer includes at least one extruder assembly comprising a nozzle and a heating element, a filament transport casing surrounding a material filament, and a liquid cooling system having a flow path through the filament transport casing.

According to some examples of the disclosure, a three-dimensional printer includes at least one extruder assembly comprising a nozzle and a heating element, a filament transport casing surrounding a material filament, and a heat isolation component provided between the heating element and the filament transport casing.

According to some examples of the disclosure, a three-dimensional printer includes at least one extruder assembly comprising a nozzle, a clog detection and cleaning system including: a sensor to detect a clogged nozzle; a lateral actuator configured to move the at least one extruder assembly between a printing position and a cleaning position; and a nozzle cleaning assembly.

In some cases, the three-dimensional printer also includes an inkjet printhead assembly having: a printhead configured to apply colored ink to a portion of a layer of a three-dimensional model printed on a build platform; and an actuation mechanism configured to move the printhead between a stowed position and a deployed position. In various cases, the three-dimensional printer also includes the at least one extruder assembly further including a heating element; a filament transport casing surrounding a material filament; and a heat isolation component provided between the heating element and the filament transport casing. In various examples, the three-dimensional printer further includes: the at least one extruder assembly further comprising a heating element; a filament transport casing surrounding a material filament; and a liquid cooling system having a flow path through the filament transport casing.

The details of one or more examples and examples are set forth in the accompanying drawings and the description below. Other features and examples will become apparent from the description, the drawings, and the claims.

### BRIEF DESCRIPTION OF THE DRAWINGS

In the following detailed description, embodiments of the disclosure are described referring to the following figures:

FIG. 1 is a sectional view of a three-dimensional printer including extruder assemblies according to examples of the present disclosure.

FIG. 2 is a sectional view of one of the extruder assemblies of FIG. 1.

FIG. 3 is a top view of the extruder assembly of FIG. 2.

FIG. 4 is a sectional view of another example of an extruder assembly according to examples of the present disclosure.

FIG. 5 is a sectional view of another example of an extruder assembly according to examples of the present disclosure.

FIG. 6 is a sectional view of another example of an extruder assembly according to examples of the present disclosure.

FIG. 7A is a sectional view of a first layer of a model that may be printed using the extruder assembly of FIG. 5.

FIG. 7B is a sectional view of a second layer of a model that may be printed using the extruder assembly of FIG. 5.

FIG. 7C is a side view of an example of an extruder assembly with a printhead in printing position.

FIG. 7D is a bottom view the extruder assembly of FIG. 7C.

FIG. 7E shows an extruder of the extruder assembly of FIG. 7C printing a first layer on a build platform.

FIG. 7F shows the printhead the extruder assembly of FIG. 7C coloring a surface of the layer of FIG. 7E with the colored ink.

FIG. 7G shows the extruder the extruder assembly of FIG. 7C printing a second layer on top of the first layer of FIG. 7E.

FIGS. 7H illustrates another step in a printing process with the extruder assembly of FIG. 7C.

FIG. 7I illustrates another step in a printing process with the extruder assembly of FIG. 7C.

FIG. 7J illustrates another step in a printing process with the extruder assembly of FIG. 7C

FIG. 7K illustrates a rotating printhead of the extruder assembly of FIG. 7C.

FIG. 7L is a front view of the printhead of FIG. 7K.

FIG. 7M shows the extruder of the extruder assembly of FIG. 7C printing a first layer on a build platform.

FIG. 7N shows the printhead of FIG. 7L coloring a surface of the layer of FIG. 7L with the colored ink.

FIG. 7O shows the printhead of FIG. 7L coloring a surface of the layer of FIG. 7L with the colored ink.

FIG. 7P illustrates the printhead of FIG. 7L printing two layers at the same time.

FIG. 7Q shows a model on a build platform from above built with the extruder assembly of FIG. 7C.

FIG. 8A is a sectional view of another example of an extruder assembly with a heat isolation component according to examples of the present disclosure.

FIG. 8B is a sectional view of another example of an extruder assembly with a heat isolation component according to examples of the present disclosure.

FIG. 8C is a sectional view of another example of an extruder assembly with a heat isolation component according to examples of the present disclosure.

FIG. 9A is a perspective view of a filament guidance system for an extruder assembly according to examples of the present disclosure.

FIG. 9B is a sectional view of a filament guide of the filament guidance system of FIG. 9A.

FIG. 9C is a side view of the filament guide of FIG. 9B.

FIG. 10 is a side view of another example of an extruder assembly according to examples of the present disclosure.

FIG. 11A is a sectional view of another example of an extruder assembly in a printing position according to examples of the present disclosure.

FIG. 11B is a sectional view of the extruder assembly of FIG. 11A during a cleaning operation.

FIG. 11C is another sectional view of the extruder assembly of FIG. 11A during the cleaning operation.

FIG. 11D is another sectional view of the extruder assembly of FIG. 11A during the cleaning operation.

FIG. 11E is another sectional view of the extruder assembly of FIG. 11A during the cleaning operation.

FIG. 11F is another sectional view of the extruder assembly of FIG. 11A during the cleaning operation.

FIG. 11G is another sectional view of the extruder assembly of FIG. 11A during the cleaning operation.

FIG. 12A is a view of an example of an extruder assembly with a clog detection and cleaning system.

FIG. 12B is another view of the extruder assembly of FIG. 12A.

FIG. 12C is another view of the extruder assembly of FIG. 12A.

FIG. 13A is a view of an extruder assembly with multiple extruders and a clog detection system.

FIG. 13B is another view of the extruder assembly of FIG. 13A.

FIG. 13C is another view of the extruder assembly of FIG. 13A.

FIG. 13D is another view of the extruder assembly of FIG. 13A.

### DETAILED DESCRIPTION

The subject matter of examples and examples of the present invention is described here with specificity to meet statutory requirements, but this description is not necessarily intended to be limiting. The described subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The following description is provided as an enabling teaching of the invention. To this end, those of ordinary skill in the relevant art will recognize and appreciate that many changes can be made to the various examples of the invention described herein, while still obtaining the beneficial results of the invention. It will also be apparent that some of the desired benefits can be obtained by selecting some of the features of the invention without utilizing other features. Accordingly, those who work in the art will recognize that many modifications and adaptations to the invention are possible and can even be desirable in certain circumstances and are a part of the invention. Thus, the following description is provided as illustrative of the principles of the invention and not in limitation thereof.

As used throughout, the singular forms “a,” “an” and “the” include plural referents unless the context clearly dictates otherwise. Thus, for example, reference to “a fastener” can include two or more such fasteners unless the context indicates otherwise. Ranges can be expressed herein as from “about” one particular value and/or to “about” another particular value. When such a range is expressed, another example includes from the one particular value and/or to the other particular value. Similarly, when values are expressed as approximations, by use of the antecedent “about,” the particular value forms another example. Moreover, the endpoints of each of the ranges are significant both in relation to the other endpoint, and independently of the other endpoint.

As used herein, the terms “optional” or “optionally” mean that the subsequently described feature may or may not be present, and that the description includes instances where said feature is present and instances where it is not. The word “or” as used herein means any one member of a particular list and also includes any combination of members of that list. Further, conditional language, such as, among others, “can,” “could,” “might,” or “can,” unless specifically stated otherwise, or otherwise understood within the context as used, is generally intended to convey that certain examples include, while other examples do not include, certain features, elements and/or steps. Thus, such conditional language is not generally intended to imply that features, elements and/or steps are in any way required for one or more particular examples. Directional references such as “up,” “down,” “top,” “bottom,” “left,” “right,” “front,” “back,” and “corners,” among others, are intended to refer to the orientation as illustrated and described in the figure (or figures) to which the components and directions are referencing.

Certain examples and features relate to movable printer devices for a three-dimensional (3D) printer. In some examples, the movable printer devices may include at least one extruder, such as two or more extruders, for generating a 3D model. The number of extruders included with the movable printer devices should not be considered limiting on the present disclosure. Each extruder may include an actuator configured to move a respective extruder into a deployed position (e.g., toward a build platform for a 3D model). A spring assembly may be positioned proximate to each of the extruders to retain the extruders in a stowed position when the extruder is not in use. Upon activation of the actuator, the actuator may apply a force to an extruder in the direction of the build platform to cause the extruder to move into the deployed position to extrude materials for generating the 3D model. In some examples, the actuator may include an electric magnet for applying a magnetic force to one of the extruders. In alternative examples, the actuator may include a motor for applying a mechanical force to the extruder. The ability of the extruders to be deployed and stowed may allow a 3D printer having multiple extruders to efficiently print a desired 3D model without the risk that a non-active extruder may contact and cause damage to a portion of the 3D model as an active extruder is applying a material to a different portion of the 3D model.

In additional and alternative examples, the movable printer devices may optionally include at least one printhead for applying a material (e.g., color ink) to a 3D model. A printhead may be positioned proximate to an extruder having a nozzle for extruding a material to generate a layer of the 3D model. The printhead may be deployed by an actuator and apply the material to the layer of the 3D model. A spring assembly may be positioned proximate to the printhead for retaining or stowing the printhead above the 3D model when the printhead is not in use (e.g., when the extruder is operating). Upon activation of the actuator, the actuator may apply a force to the printhead in the direction of the build platform to cause the printhead to move into a deployed position for applying colored ink or some other material to the layer. In some examples, the actuator may include an electric magnet for applying a magnetic force. In alternative examples, the actuator may include a motor for applying a mechanical force. The printhead may be coupled to a cartridge having the material for applying to the layer. In some examples, the material may include colored ink having one or more colors, similar to an inkjet printer cartridge, for applying to the layer of material extruded by the extruder nozzle. The use of a printhead having a cartridge with multiple colors may allow the printer assembly to generate a 3D model having multiple colors without affecting the size of the printer assembly. For example, the use of such a printhead may reduce the number of extruders otherwise required for applying a material having each of the desired colors for the 3D model.

### Multiple Extruder System

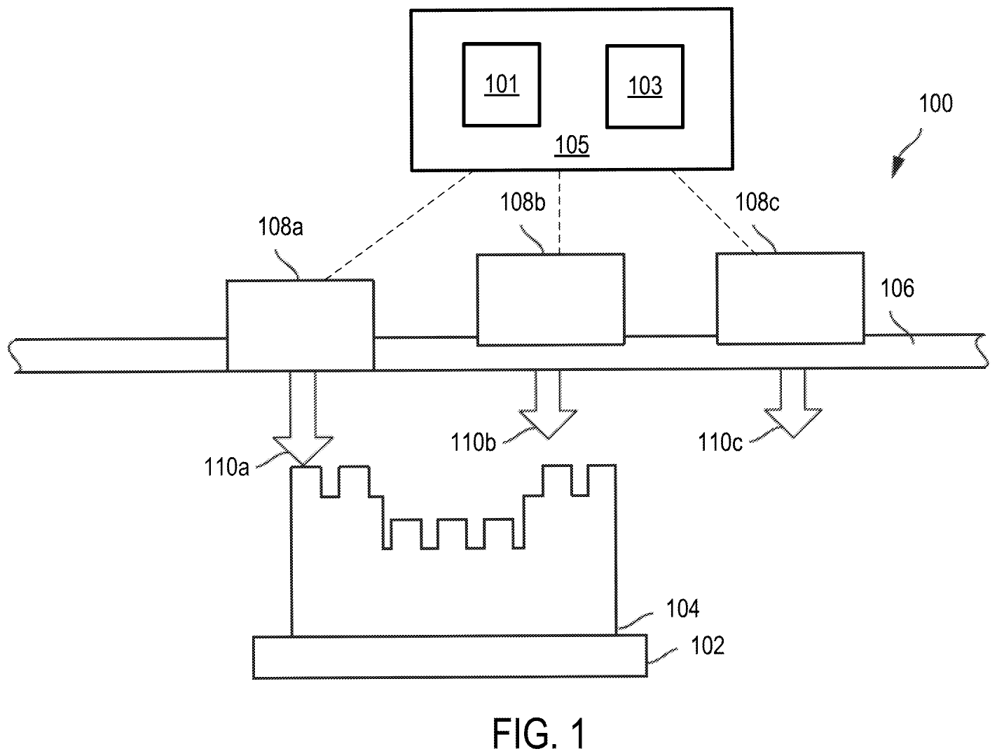

FIG. 1 illustrates an example of a 3D printer assembly 100. The printer assembly 100 includes a build platform 102 that may serve as a surface for a 3D model 104 to be printed by the printer assembly 100. The printer assembly 100 may also include a base platform 106. The printer assembly 100 includes at least one extruder assembly 108 mounted to the base platform 106. In the present example, the printer assembly 100 includes three extruder assemblies 108a, 108b, 108c mounted to the base platform 106. However, it will be appreciated that the number of extruder assemblies 108 should not be considered limiting on the present disclosure. For example, the printer assembly 100 may include one extruder assembly, two extruder assemblies, more than .three extruder assemblies, or various other combinations of extruder assemblies as desired.

In some examples, the base platform 106 may include a planar surface for mounting the extruder assemblies 108a, 108b, 108c, although in other examples, the surface need not be planar. In other examples, the base platform 106 may include a bar or other surface for mounting the extruder assemblies 108a, 108b, 108c. The base platform 106 may be positioned proximate to the build platform 102 to allow the extruder assemblies 108a, 108b, 108c to print the model 104.

Each extruder assembly 108a, 108b, 108c includes a nozzle 110a, 110b, 110c, respectively, for extruding a material to generate the model 104. In some examples, the nozzles 110a, 110b, 110c may optionally include a heating element 111 that heats each of the nozzles 110a, 110b, 110c, respectively. The nozzles 110a, 110b, 110c may be heated to a temperature sufficient to soften or melt the material used to generate the model 104. In some examples, the material may include a plastic polymer such as a thermoplastic or thermosetting polymer that may be melted by the heat of the nozzle 110a, 110b, 110c; however, in other examples, the material may be various other materials or combinations of materials suitable for printing with the printer assembly 100. The melted material may be applied by the nozzle 110a, 110b, 110c to the build platform 102 or the model 104. As the melted material cools, the material may harden and set to create the model 104.

In some examples, the build platform 102 is configured to move toward and away from the base platform 106 and around one of the nozzles 110a, 110b, 110c to cause the melted material extruded from the nozzle 110a, 110b, 110c to form a desired shape of the model 104. In other examples, the base platform 106 is configured to move toward and away from the build platform 102 to form the material extruded from the nozzle 110a, 110b, 110c into the desired shape of the model 104.

In some examples, when more than one extruder assembly 108 is included, the extruder assemblies 108a, 108b, 108c may each include a different type of material for forming the model 104. In other examples, the extruder assemblies 108a, 108b, 108c may each include the same type of material, but each having a different color. For example and without limitation, the extruder assembly 108a may include an red plastic, the extruder assembly 108b may include a blue plastic, and the extruder assembly 108c may include a green plastic. In this example, the printer assembly 100 may use the extruder assemblies 108a, 108b, 108c to generate a plastic model 104 that includes red, blue, and green portions. Printing with different colors (without varying the material type) does not necessarily require multiple extruders in a system that has the capability to color using the printer assembly 100, as described in more detail below. Typically, more than one extruder assembly is used when you need to print different materials (ABS, PET, Nylon, etc.) and/or when you need to print with a wash-away or with another technology removable support material. It is also possible to print with a white ABS in one extruder and a black ABS in another extruder.

Multiple extruders may be useful for printing with different types of materials and/or for support material removal. In these embodiments, two extruder assemblies 108a, 108b may be used to print with two different materials (for example, one solid material, and one elastic material) or with one material while the second extruder is used to remove support material. In further embodiments, three extruder assemblies 108a, 108b, 108c may be used to print a solid material, print a flexible material (or another type of solid material), and remove support material from the model.

In some examples, each extruder assembly 108a, 108b, 108c may be active at a particular time to extrude a respective material. For example, the nozzle 110a of extruder assembly 108a may beat and extrude the red plastic while extruder assemblies 108b, 108c are inactive. In some optional examples where the nozzles 110a, 110b, 110c include heating elements 111, only the nozzle 110a, 110b, 110c in the active extruder assembly 108a, 108b, 108c may be heated. In alternative examples, all of the nozzles 110a, 110b, 110c may be configured to heat at the same time and only the active extruder assembly 108a, 108b, 108c will supply material to its nozzle 110a, 110b, 110c for melting and extruding to generate the model 104. In other examples, at least two extruder assemblies may extrude material for generating the model 104 at the same or overlapping time period.

As described in detail below, the extruder assemblies 108a, 108b, 108c may include devices to allow the nozzle 110a, 110b, 110c, respectively, to be raised from and lowered toward the build platform 102 or the model 104 (e.g., stowed and deployed, respectively). Although three extruder assemblies 108a, 108b, 108c are shown in FIG. 1, a printer assembly may include any number of extruder assemblies, including one, without departing from the scope of the present disclosure.

Referring to FIGS. 1-3, reference is made to the extruder assembly 108a, although it will be appreciated that the description is equally applicable to the extruder assemblies 108b and 108c in those examples where multiple extruder assemblies are present. In various examples, the extruder assembly 108a includes an extruder body 112 coupled to the nozzle 110a. In some examples, the extruder body 112 and the nozzle 110a may be coupled such that the extruder body 112 and the nozzle 110a move in concert, although they need not. In some examples, the extruder body 112 may house an engine or motor (not shown) for operating the extruder assembly 108a. In additional and alternative examples, the extruder body 112 may also include a container or other device (not shown) for housing the material used by the extruder assembly 108a to generate the model 104 shown in FIG. 1.

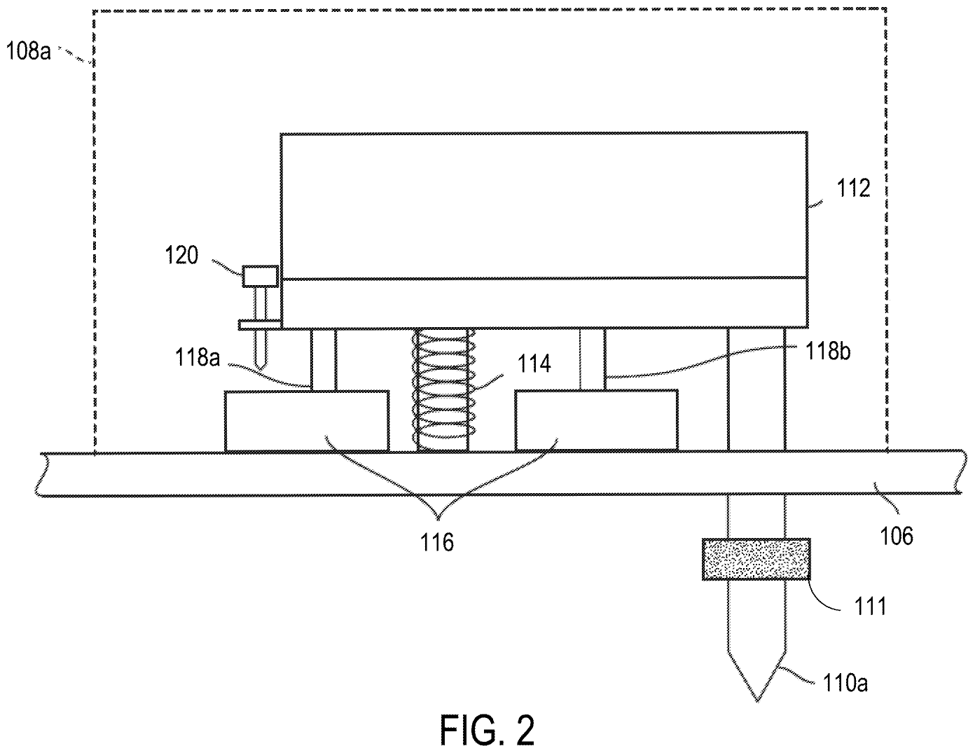

As illustrated in FIG. 2, in various examples, the extruder assembly 108a includes a spring assembly 114 positioned in the extruder assembly 108a to apply a force in a direction to stow the nozzle 110a. For example, the spring assembly 114 may include one or more springs positioned between a base platform 106 of the extruder body 112 and the base platform 106 to cause the nozzle 110a to lift up and away from the build platform 102 or the model 104 (or the base platform 106).

The extruder assembly 108a includes an actuator for deploying the nozzle 110a toward the build platform 102 or the model 104. In the present example, the actuator includes an electric magnet 116; however, in various other examples, the actuator may be various other mechanisms suitable for deploying the nozzle 110a toward the build platform 102 or the model 104 (or the base platform 106).

As illustrated in FIG. 2, in various examples, the electric magnet 116 is positioned in the extruder assembly 108a to apply a force to the extruder body 112 in the direction of the build platform 102 or the model 104. The electric magnet 116 may be configured to produce an electric current that creates a magnet field. In some examples, the electric magnet 116 may include coiled wires positioned proximate to each other and having a ferromagnetic or ferromagnetic material to create the magnetic field. When the electric magnet 116 is activated, the force applied by the electric magnet 116 may be greater than the force applied by a spring assembly 114 to allow the nozzle 110a to be deployed toward the build platform 102 or the model 104. In some examples, the extruder assembly 108a may optionally include guide pins 118a, 118b coupled to the extruder body 112 to support and guide the extruder body 112 movement in response to the forces applied by the spring assembly 114 and the electric magnet 116.

In some optional examples, the extruder assembly 108a may also include or be communicatively coupled to a controller 105 having a processing device 101 and a memory device 103. The processing device 101 may be configured to execute instructions including one or more algorithms for causing the actuator to apply the force to the extruder body 112 in the direction of the build platform 102 or the model 104. The instructions may be stored in the memory device 103. Non-limiting examples of the processing device 101 may include a field-programmable gate array (“FPGA”), an application-specific integrated circuit (“ASIC”), a microprocessor, etc. Non-limiting examples of the memory device 103 may include electrically erasable and programmable read-only memory (“EEPROM”), a flash memory, or any other type of memory. In some examples, at least a portion of the memory device 103 may include a computer-readable medium from which the processing device can read the instructions (e.g., an electronic, optical, magnetic, or other storage device capable of providing the processing device with computer-readable instructions or other program code). Non-limiting examples of a computer-readable medium may include magnetic disks, memory chips, ROM, random-access memory (“RAM”), an ASIC, a configured processor, optical storage, or any other medium from which a compute processor can read the instructions. The instructions may include processor-specific instructions generated by a compiler or an interpreter from code written in any suitable computer-programming language, including, for example, C, C+++, C#, etc.

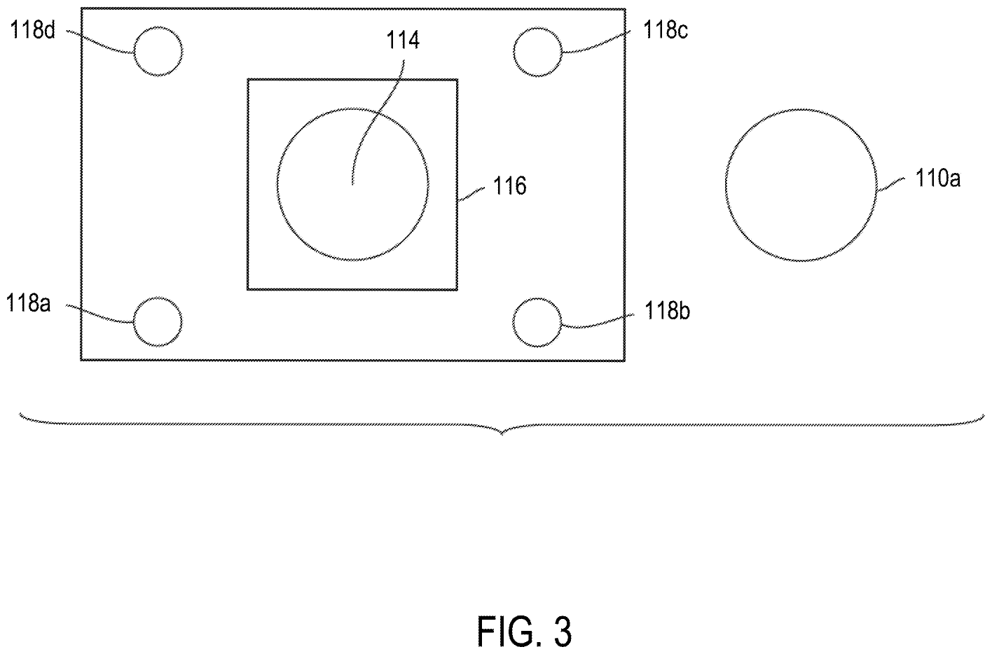

FIG. 3 shows a top view of the extruder assembly 108a of FIG. 2. As illustrated in FIG. 3, in some examples, the spring assembly 114 is positioned through the electric magnet 116, although it need not be. The extruder assembly 108a includes four guide pins 118a, 118b, 118c, 118d positioned at opposing corners of the electric magnet to guide the extruder body toward and away from the build platform 102 or the model 104. The location and number of guide pins should not be considered limiting on the current disclosure as any number of guide pins, including zero guide pins, at various positions may be included.

In some examples, the electric magnet 116 may be activated in response to an activation of the extruder assembly 108a. For example, in the non-limiting example in which only one nozzle of a printing assembly is heated at a time, the electric magnet 116 may be configured such that activation of the heating element 111 of the nozzle 110a causes the electric magnet 116 to apply the force to the extruder body 112. Applying the force to the extruder body 112 deploys the nozzle 110a toward the build platform 102 or the model 104. When the nozzle 110a is deployed, material may be extruded through the nozzle 110a to generate the model 104. In other examples in which multiple nozzles of a printing assembly are heated, the electric magnet 116 may be configured such that activation of an extruding element of the nozzle 110a to extrude the material to generate the model 104 causes the electric magnet 116 to apply the force to deploy or lower the nozzle 110a toward the build platform 102 or the model 104.

Returning to FIG. 2, the extruder assembly 108a may also optionally include a stopper 120 to control the distance that the extruder body 112, and the nozzle 110a, by extension, may deploy in response to the operation of the electric magnet 116. In the present example, the stopper 120 is a screw, although in various other examples, the stopper 120 may be a pin, bolt, tab, rib, or various other components suitable for controlling the distance that the extruder body 112 may deploy. In some examples, as illustrated in FIG. 2, the stopper 120 may be coupled to the extruder body 112 and positioned above the electric magnet 116 as shown in FIG. 2. In other examples, the stopper 120 may be integrally formed with the extruder body 112 and may positioned at various other locations on the extruder body 112. In the present example, as the extruder body 112 is lowered in response to the operation of the electric magnet 116, the screw may engage or contact a surface of the electric magnet, creating an interference that prevents the extruder body 112 and the nozzle 110a from continuing to deploy or lower toward the build platform 102 or the model 104. In additional examples, the stopper 120 may be torqued such that a position of an end portion of the stopper 120 may be adjusted to be closer to or farther than the bottom portion of the extruder body 112 to change the distance that the extruder body 112 is able to deploy. In response to a deactivation of the electric magnet 116, the spring assembly 114 may cause the extruder body 112 and the nozzle 110a to move into a stowed position (e.g., away from the build platform 102 or the model 104).

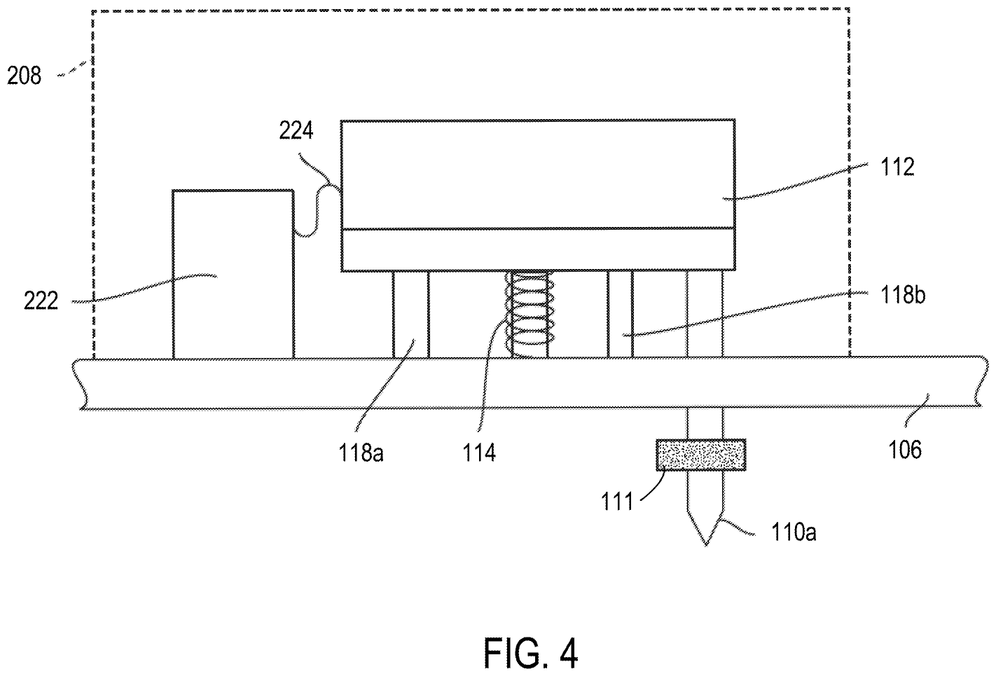

FIG. 4 shows another example of an extruder assembly 208. The extruder assembly 208 is substantially similar to the extruder assembly 108a except that the actuator of the extruder assembly 208 includes a motor 222 in place of the electric magnet 116 of the extruder assembly 108a shown in FIG. 2. Non-limiting examples of the motor 222 may include an electric motor, piezoelectric motor, a stepper motor, or various other motors suitable for applying a mechanical force to the extruder body 112 to cause the extruder body 112 to deploy from the stowed position to the deployed position. In some examples, the motor 222 may be coupled to a motor housed in the extruder body 112 by a control line 224. In additional and alternative examples, the control line 224 may provide power to the motor 222 using the power supplied for operating the motor housed in the extruder body 112. When the motor 222 is activated, a force is applied to deploy the extruder body 112 and the nozzle 110a into position. When the motor 222 is deactivated, the force applied by the spring assembly 114 may cause the extruder body 112 and the nozzle 110a to return to the stowed position.

The printer assembly 100 may include various combinations of actuators when more than one extruder assembly is provided. For example, in some examples, the extruder assemblies 108a, 108b, 108c may include the same type of actuator (e.g., electric magnet 116, motor 222) or different types of actuators configured to deploy the nozzles 110a, 110b, 110c. In some examples, during operation of the printer assembly 100, only one of the actuators may be activated at a time such that only one nozzle 110a, 110b, 110c is deployed at a time.

The person of ordinary skill in the relevant art will understand that these are just examples of actuation solutions that may be incorporated to adjust the vertical positioning of the extruder assemblies 108a, 108b, 108c. Any suitable mechanical, electrical, pneumatic, magnetic, or any other solution may be used to control the vertical positioning of the extruders.

The multiple extruder assemblies 108a, 108b, 108c may be used alone or in conjunction with any of the systems described herein with respect to 3D printer assemblies.

### Inkjet Printhead System

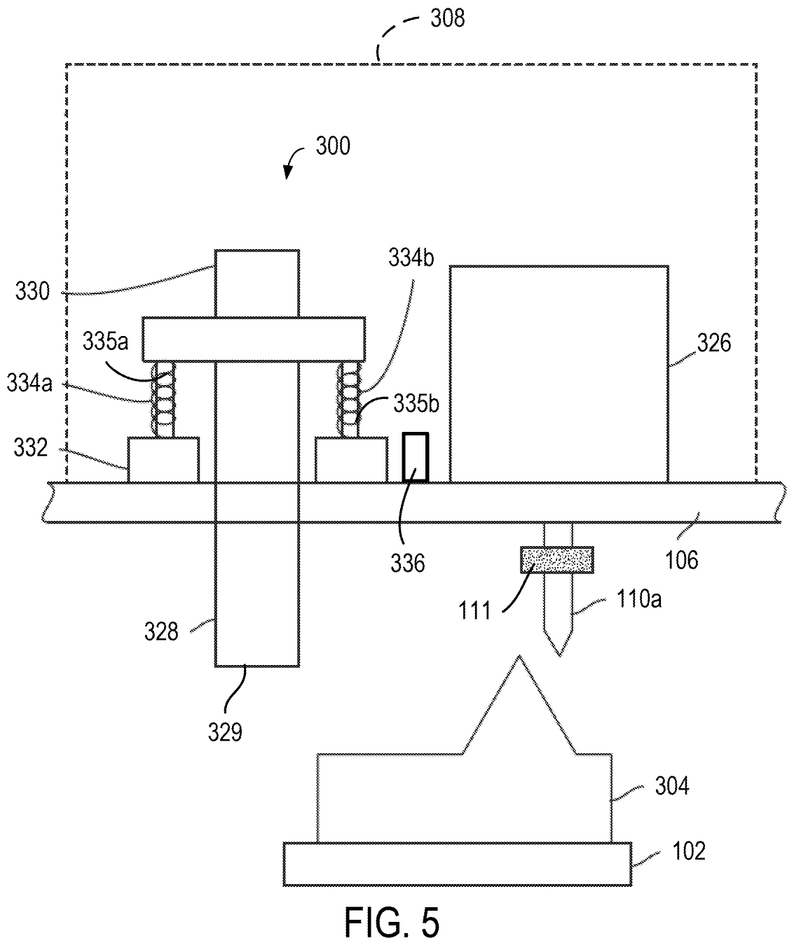

In some embodiments, at least one extruder assembly may optionally include an inkjet printhead assembly 300 configured to deploy and stow a printhead. The number of printer assemblies should not be considered limiting on the present disclosure. For example, FIG. 5 shows an example of an extruder assembly 308 that may be used in the printer assembly 100 of FIG. 1 in place of extruder assembly 108a. The extruder assembly 308 is substantially similar to the extruder assembly 108a except that the extruder assembly 308 further includes an extruder body 326 and a printhead 328. The extruder body 326 is coupled to a nozzle 110a″. The nozzle 110a″ may be configured to extrude a material for generating the 3D model 304 on the build platform 102. In the embodiments that include a single extruder assembly 308, it may not be necessary to include an actuator, spring, motor, magnet, or other actuating device to cause the nozzle 110a to lift up and away from or to deploy toward the build platform 102 or the model 104 (or the base platform 106).

The printhead 328 may be configured to apply ink to the 3D model 304. Specifically, the inkjet printhead assembly 300 may include a nozzle or other end portion 329 for extruding ink that may be applied to the model 304. In some examples, the material extruded by the nozzle 110a may include a clear plastic material and the printhead 328 may include a colored ink capable of dying or otherwise printing on the clear plastic material to color the 3D model 304. The printhead 328 is coupled to a cartridge 330. The cartridge 330 may include a housing for containing the material extruded by the printhead 328. For example, the cartridge 330 may include an ink cartridge having colored ink of one or more colors for applying to the model 304 by the printhead 328.

In some examples, the printhead 328 may be configured to move into a deployed position in response to an activation of an actuator. In the present example, the actuator includes an electric magnet 332; however, in various other examples, the actuator may be various other mechanisms suitable for deploying the printhead 328 toward the build platform 102 or the model 104 (or the base platform 106).

In the present example, the electric magnet 332 is configured to cause the printhead 328 to lower toward the build platform 102 or the model 304. The electric magnet 332 may operate similar to the electric magnet 116 described above with respect to FIG. 2. For example, the electric magnet 332 may be configured to activate in response to an activation of the printhead 328 to apply colored ink from the cartridge 330 to the model 304. Upon activation of the electric magnet 332, a magnetic force may be applied to the printhead 328 to deploy the printhead.

The extruder assembly 308 may also include a spring assembly. In some examples, the spring assembly may include springs 334a, 334b that are positioned between the electric magnet 332 and a portion of the printhead 328 to apply a magnetic force to the printhead 328 away from the build platform 102 or the model 304. The number or location of the springs 334 should not be considered limiting on the current disclosure In some examples, the springs 334a, 334b may optionally surround guide pins 335a, 335b for supporting and guiding the printhead movement. The number or location of guide pins 335 should not be considered limiting on the current disclosure. In additional and alternative examples, the extruder assembly 308 may also include or be communicatively coupled to a processing device and a memory device as described for the extruder assembly 108a.

In some examples, the extruder assembly 308 may optionally include a monitoring device 336. The monitoring device 336 may be positioned proximate to the printhead 328. The monitoring device 336 may be configured to receive information related to the position of the printhead 328 during operation of the extruder assembly 308. In some examples, the monitoring device 336 may be communicatively coupled to a processing device configured to receive the information from the monitoring device 336 and determine whether the printhead 328 is in a correct position for applying the applying ink to the model 304. Non-limiting examples of the monitoring device may include one or more cameras, sensors, or other devices capable of receiving information regarding the position of the printhead 328. Although the monitoring device 336 is shown as positioned above the base platform 106 in FIG. 5, the monitoring device 336 may be located in any position to allow the monitoring device 336 to receive information regarding the position of the printhead 328 without departing from the scope of the present disclosure. For example, the monitoring device 336 may be positioned below the base platform 106, on or proximate to the actuation device, or directly on the printhead 328.

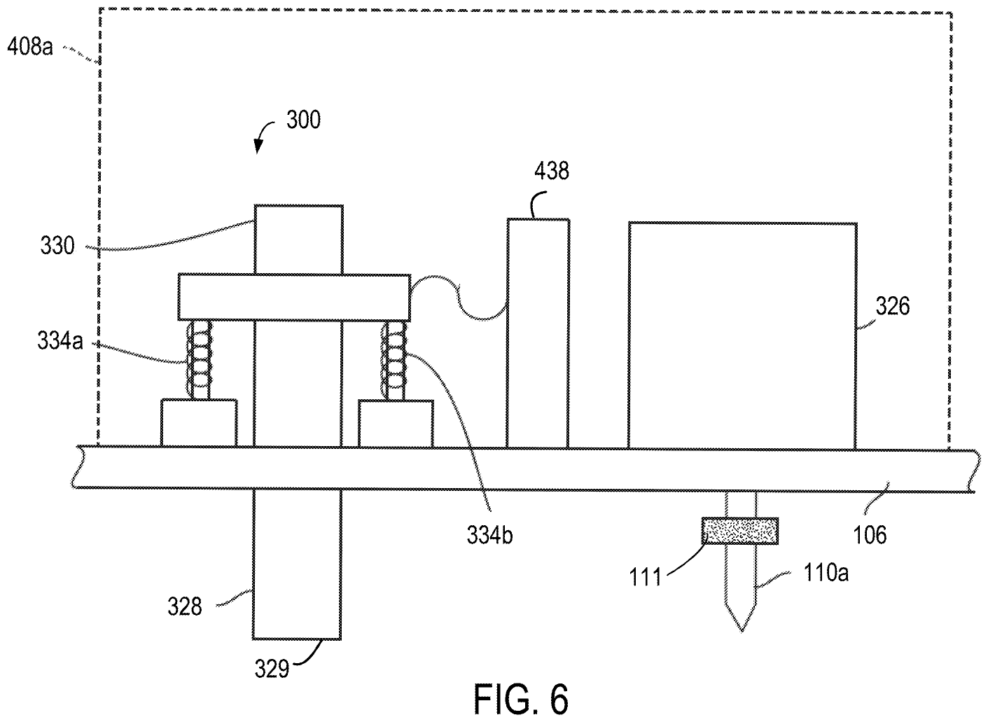

FIG. 6 illustrates another example of an extruder assembly 408. The extruder assembly 408 is substantially similar to the extruder assembly 308 except that the actuator of the extruder assembly 408 includes a motor 438 in place of the electric magnet 332 shown in FIG. 5. The motor 438 may be coupled to a motor housed by the inkjet printhead assembly 300 by a control line 440. Similar to the motor 222 shown in FIG. 4, the motor 438 may be configured to apply a mechanical force to deploy the printhead 328. The extruder assembly 408 may include a spring assembly including springs 334a, 334b that may be positioned to apply an opposing force away from the build platform 102 to stow the printhead 328.

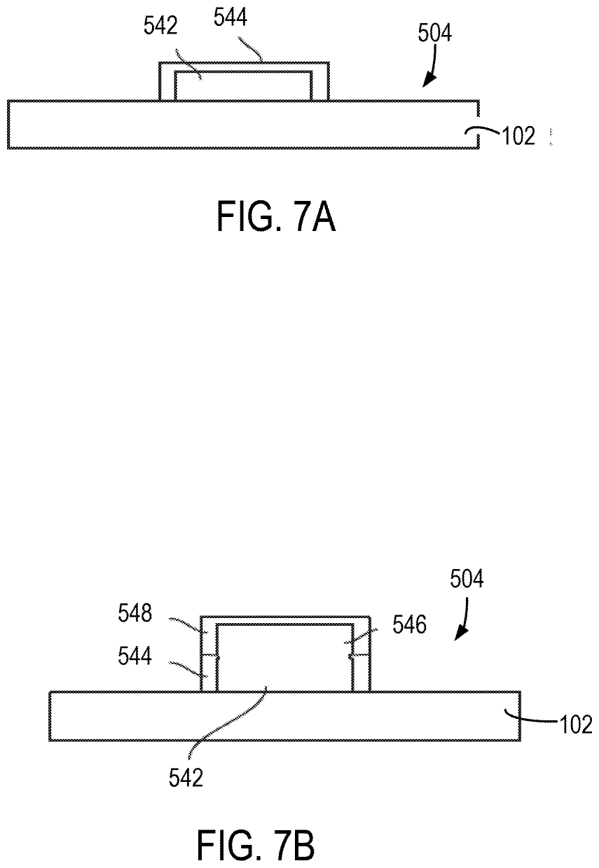

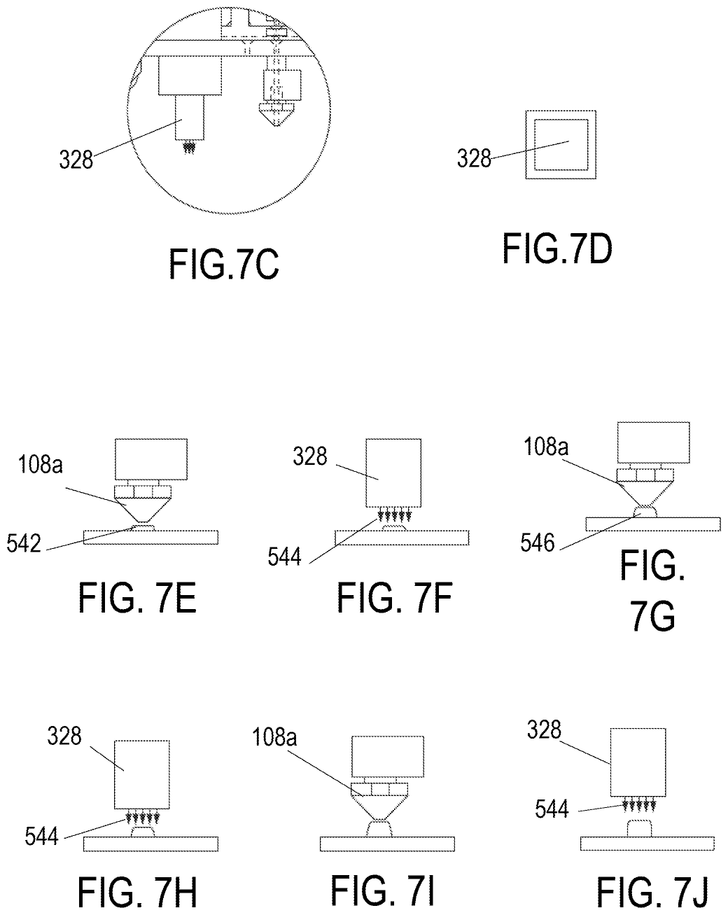

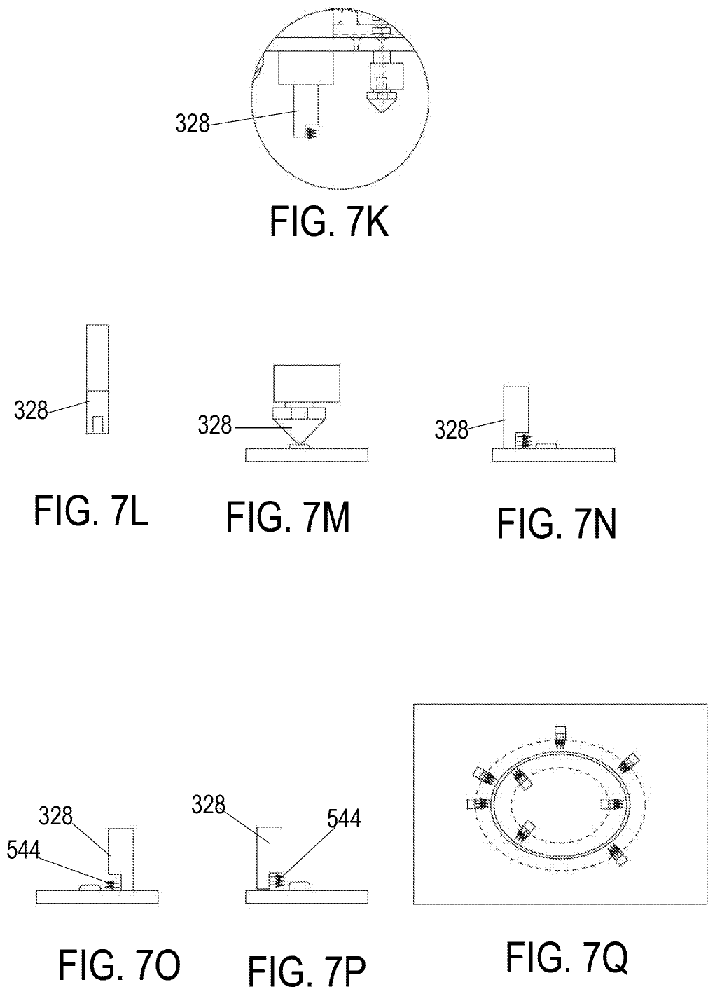

FIGS. 7A and 7B show examples of material that may be extruded from the nozzle 110a and the printhead 328 into layers of a 3D model 504. During a printing, the nozzle 110a may apply a first layer 542 of material on the build platform 102 for the 3D model 504, as well as additional layers as optionally desired. In some examples, the material may include a clear plastic polymer, although it may include various other suitable materials in various other examples.

When the printhead 328 is included, during printing, the printhead 328 may be deployed by an actuator (e.g., electric magnet 332, motor 438) to apply colored ink 544 on the first layer 542. In some examples, the printhead 328 may be configured to apply the colored ink 544 only on the top of the layer 542 or a portion of the layer 542. The following details describe two embodiments of a printhead 328, but the person of ordinary skill in the relevant art will understand that any suitable printhead 328 design may be used, including those that spray at an angle, upward, in an arc, or any other suitable pattern or direction.

For example, FIG. 7C illustrates a square flat printhead 328 in printing (i.e., lowered) position. The arrows indicate the direction of the ejected ink 544 onto the model 1004. FIG. 7D shows the printhead from the bottom, wherein the print nozzles are arranged in a square field. The square field contains the nozzles for all used colors and, if equipped, for coating and protection seal. As a result, the printhead 328 can print in X and Y directions in any angle.

FIG. 7E shows the extruder 108a printing the first layer 542 on the build platform 102. FIG. 7F shows the printhead 328 coloring a surface of the layer 542 with the colored ink 544. FIG. 7G shows the extruder 108a printing the second layer 546 on top of the first layer 542. During the process, the second layer 546 compresses the colored ink 544 that was applied on top of the first layer 542. Because of adhesion, the colored ink 544 automatically fills in any gaps between the layers 542, 546. In some examples, the temperature of the second layer 546 may cause the first layer 542 to melt such that the first layer 542 and the second layer 546 are melted together as shown in FIG. 7B. FIGS. 7H-7J illustrate that these steps repeat until the whole model 504 is completed.

In some embodiments, the system may be configured to print a base coating, followed by coloring, then followed by a final seal layer. In further embodiments, a coating and color layer or color layer and seal layer are options.

In additional and alternative examples, the printhead 328 may be turnable to apply the colored ink 544 to sides of the layer 542. For example, FIG. 7K illustrates a rotating printhead 328 in printing (i.e., lowered) position. The arrows indicate the direction of the ejected ink 544 onto the model 1004. FIG. 7L shows the printhead 328 from the front, wherein the print nozzles are arranged in a square field. It contains nozzles for all color and, if equipped, also for base coating and protection seal. The square field contains the nozzles for all used colors and, if equipped, for coating and protection seal. As a result, the printhead 328 can print in X and Y directions in any angle.

FIG. 7L shows the extruder 108a printing the first layer 542 on the build platform 102. FIG. 7M shows the printhead 328 coloring a surface of the layer 542 with the colored ink 544 from the outside of the model 504. FIG. 7N shows the printhead 328 coloring a surface of the layer 542 with the colored 544 from the backside/inside of the model 504. Depending on printhead construction and model complexity, it is possible to print two or more layers at the same time, as shown in FIG. 7O.

In some embodiments, the system may be configured to print a base coating, followed by coloring, then followed by a final seal layer. In further embodiments, a coating and color layer or color layer and seal layer are options.

Various printing options include but are not limited to (1) printing directly with the colored ink onto the model; (2) printing a base coating first (white) similar to the type used on the ink printable CD's; (3) printing a protectant seal (shiny or matte) to protect and conserve the print).

In some embodiments, ultraviolet light may be used to dry and/or harden one or more of the layers.

FIG. 7P shows the model 1004 on the build platform 102 from above. In this example, the model 1004 is an elliptical vase, but can have any suitable shape or configuration. FIG. 7Q illustrates some of the different positions the printhead 328 is able to have during the printing process. Because of the variety of positions, in many cases, the printhead 328 is rotatable over a certain range of movement.

In one example, the printhead 328 may be turnable in a range of 320-360 degrees, or more specifically in a range of 330-355 degrees, or more specifically up to about 355 degrees, or more specifically up to about 360 degrees to apply the colored ink 544 to all sides of the layer 542. In other examples, an extruder assembly may include multiple printheads, each responsible for applying the colored ink 544 to an appropriate portion of the layer 542. For example, an extruder assembly may include two printheads, each turnable up to about 180 degrees (or various other angles of rotation) to apply the colored ink 544 to the layer 542. In another example, an extruder assembly may include three printheads, each turnable up to about 120 degrees (or various other angles of rotation) to apply the colored ink 544 to the layer 542. In a third example, an extruder assembly may include four printheads, each turnable up to about 90 degrees (or various other angles of rotation) to apply the colored ink 544 to the layer 542.

As described above, the printhead 328 may rotate while the remainder of the inkjet printhead assembly 300 remains stationary, or the entire inkjet printhead assembly 300 may rotate. Rotation of the printhead 328 and/or the inkjet printhead assembly may be accomplished using any suitable mechanical, electrical, pneumatic, magnetic, or other solution.

During the printing process, the camera or other monitoring device may optionally be included to monitor the printing of the 3D model and improve quality by providing feedback to the processing device controlling the printer assembly. When combined with the clog detection and cleaning system 868, as described below, the same camera 976 may be used to monitor both systems. In some embodiments, the camera 976 (or other camera as needed) is rotatable. In further embodiments, two cameras may be used to monitor the printing process. In still further embodiments, the camera may be mounted on the side of the printhead 328 and rotatable to maintain substantially parallel alignment with the printhead 328.

In some embodiments, a distance sensor may also be included for adjusting a distance from the printhead 328 to the model 504.

The inkjet printhead assembly 300 may be used alone or in conjunction with any of the systems described herein with respect to 3D printer assemblies.

### Thermal Isolation Cooling System

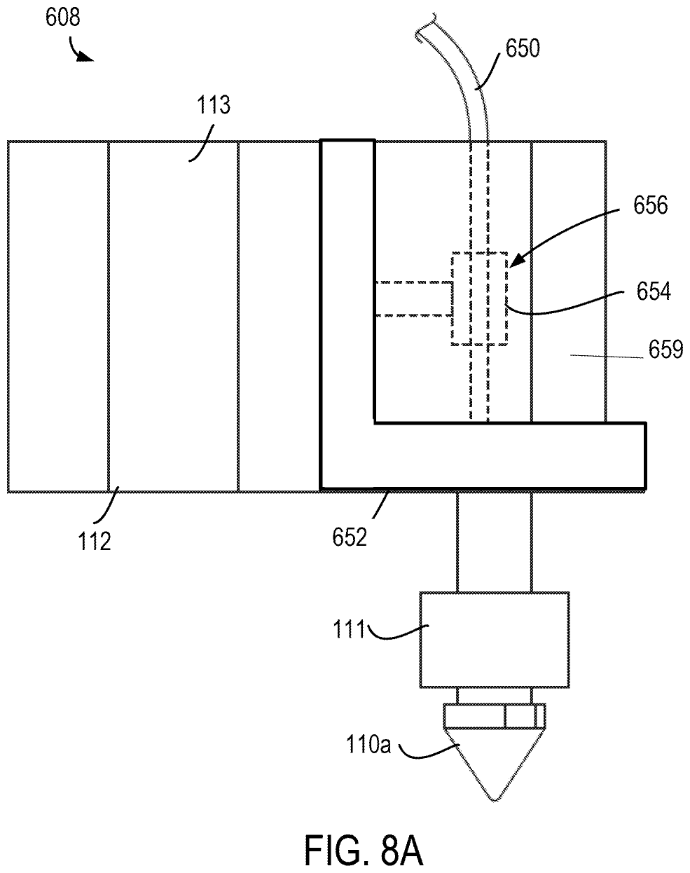

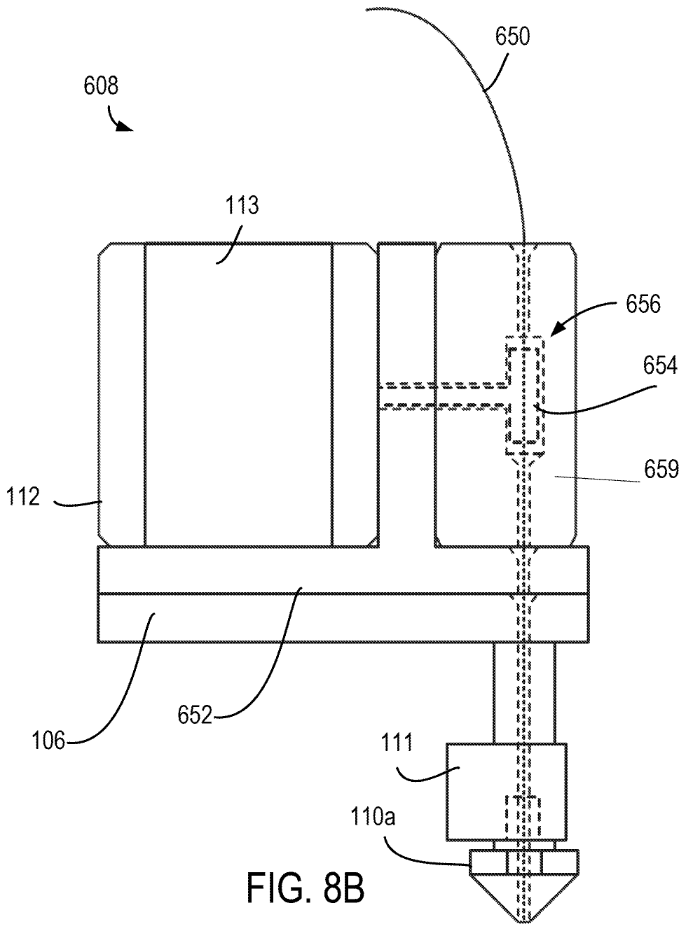

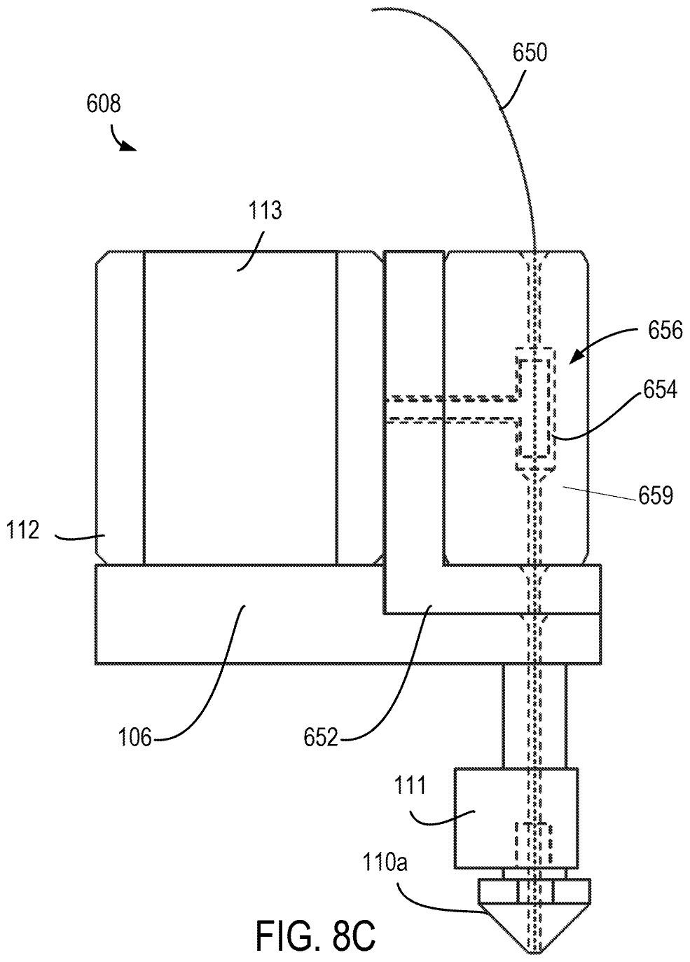

FIGS. 8A-C illustrates another example of an extruder assembly 608 that optionally includes a heat isolation component 652. The heat isolation component 652 may be a portion of the base platform 106 (see FIG. 8A). In these components, the heat isolation component 652 may be integrally formed with the base platform 106 as a unitary component or may be separately connected to the base platform 106. In other examples, the heat isolation component 652 is a component on the base platform (see FIGS. 8B and 8C).

The heat isolation component 652 may be provided between the heating element 111 and a filament transport casing 654 surrounding the material filament 650 to thermally isolate the supply filament 650. Without the heat isolation component 652, in some examples, the heat from the heating element 111 may transfer to the filament transport casing 659. The heat from the filament transport casing 659 may in turn transfer to the supply filament 650 inside the filament transport casing 659. The heated supply filament 650 may then become too soft and/or begin to melt before entering the nozzle 110a, which may cause the nozzle 110a to become clogged.

In some embodiments, the heat isolation component 652 may also optionally be provided between the heating element 111 /extruder motor 113 (which is housed within the extruder body 112) and the filament transport casing 654.

In further embodiments, the heat isolation component 652 may further be positioned so as to isolate a filament guide 654 of a filament guidance system 656, which is configured to guide the supply filament 650 to the nozzle 110a, from the heating element 111/extruder motor 113. In other examples, the heat isolation component 652 may be provided between the filament transport casing 659 and/or filament guide 654 and any other components that may melt the filament 650. For example, the heat isolation component 652 may be between the base platform 106 (and the heating element 111) and the filament transport casing 659/filament guide 654 as well as between the extruder motor 113 and the filament transport casing 659/filament guide 654 (see FIG. 8B). As another example, the heat isolation component 652 may be between the base platform 106 (and the heating element 111) and the filament transport casing 659/filament guide 654, between the extruder motor 113 and the filament transport casing 659/filament guide 654, and between the extruder motor 113 and the base platform 106 (see FIG. 8C).

Furthermore, during assembly of the heat isolation component 652 with the other components, it is important to avoid formation of thermal bridges. A person of ordinary skill in the relevant art will understand that there are several options that can be used to assemble the components without also creating a thermal bridge, such options including but not limited to insulating fasteners, clips, thermal isolation tubes, and thermal isolation screws just to name a few of the available options.

The heat isolation component 682 may be used alone or in conjunction with any of the systems described herein with respect to 3D printer assemblies.

In the embodiments that include a single extruder assembly 608, it may not be necessary to include an actuator, spring, motor, magnet, or other actuating device to cause the nozzle 110a to lift up and away from or to deploy toward the build platform 102 or the model 104 (or the base platform 106).

### Liquid Cooling System

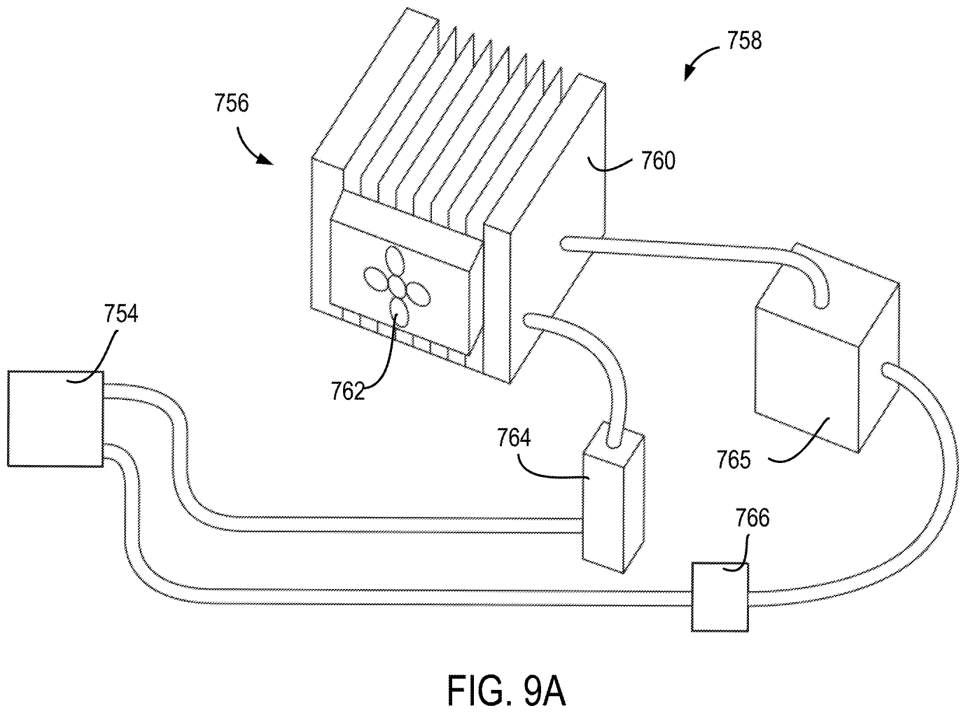

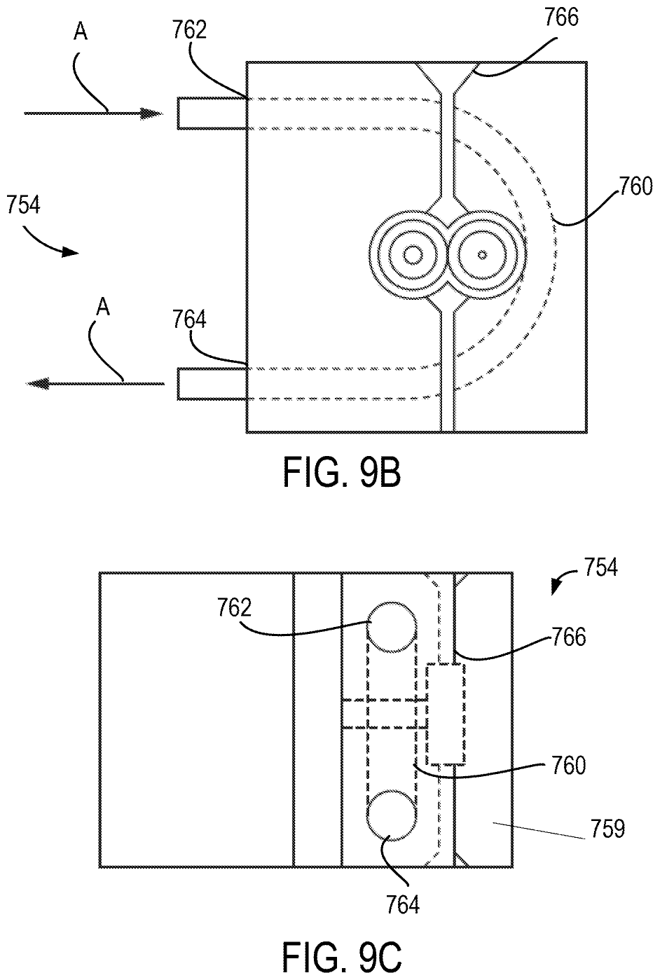

FIGS. 9A-C illustrate further embodiments of a filament guidance system 756 for an extruder assembly. Similar to the filament guidance system 656, the filament guidance system 756 includes a filament transport casing 759 and a filament guide 754. However, unlike the filament guide 654, the filament guide 754 is cooled through a cooling system 758 to control the temperature of the filament transport casing 759 and filament guide 754 (and by extension the supply filament 650 that is moved through the filament transport casing 759 and the filament guide 754). In many embodiments, the filament transport casing 759 is made of out materials that are thermally conductive, such as but not limited to aluminum. Due to the conductive properties of the filament transport casing 759, circulating a cooling fluid through a channel inside the filament transport casing 759 keeps the filament transport casing 759 cool.

The cooling system 758 is similar to systems used for cooling central processing units in computers. In the present embodiments, the cooling system 758 is a fluid cooling system that may include a temperature exchange 767, a fan 761, a pump 763, an optional fluid reservoir 765, and an optional sensor 768 (such as a temperature sensor, pressure sensor, or other monitoring device as described above configured to detect an aspect of the fluid flowing through the cooling system 758). The components of the cooling system 758 should not be considered limiting on the current disclosure as fewer, additional, or alternative components may be utilized to cool the filament guide 754. The fluid used with the cooling system 758 should not be considered limiting on the current disclosure.

As illustrated in FIGS. 9B and 9C, the modified filament guide 754 defines a flow path 760 through the filament transport casing 759 and the filament guide 754 such that the fluid may enter the filament transport casing 759 and the filament guide 754 through an inlet 762, flow through the filament guide 754, and exit through an outlet 764, as indicated by the arrows A. The locations of the inlet 762 and the outlet 764 should not be considered limiting on the current disclosure. In various examples, the flow path 760 may optionally be provided adjacent to a filament channel 766 that is configured to direct the supply filament 650 through the filament guide 754.

The liquid cooling system 758 may be used alone or in conjunction with any of the systems described herein with respect to 3D printer assemblies.

In the embodiments that include a single extruder assembly, it may not be necessary to include an actuator, spring, motor, magnet, or other actuating device to cause the nozzle 110a to lift up and away from or to deploy toward the build platform 102 or the model 104 (or the base platform 106).

### Clog Detection and Cleaning System

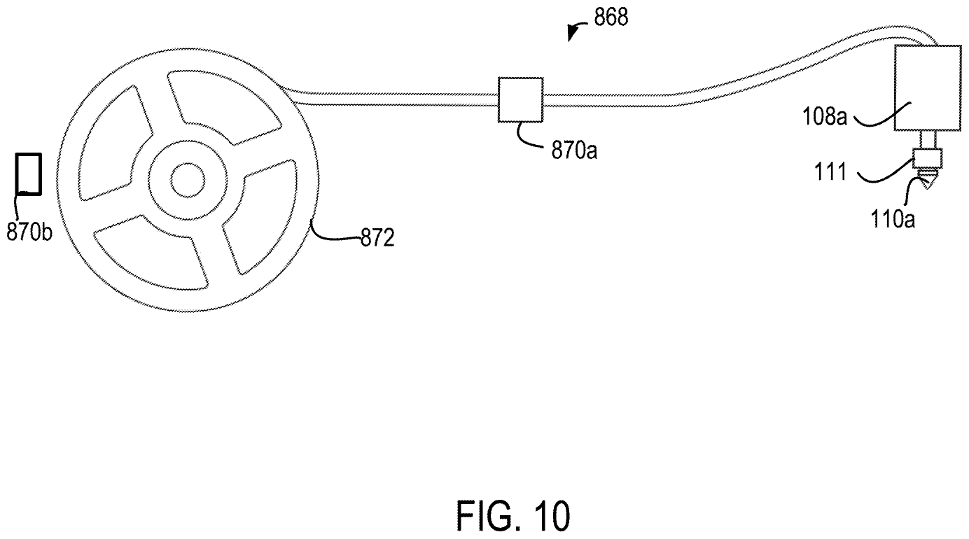

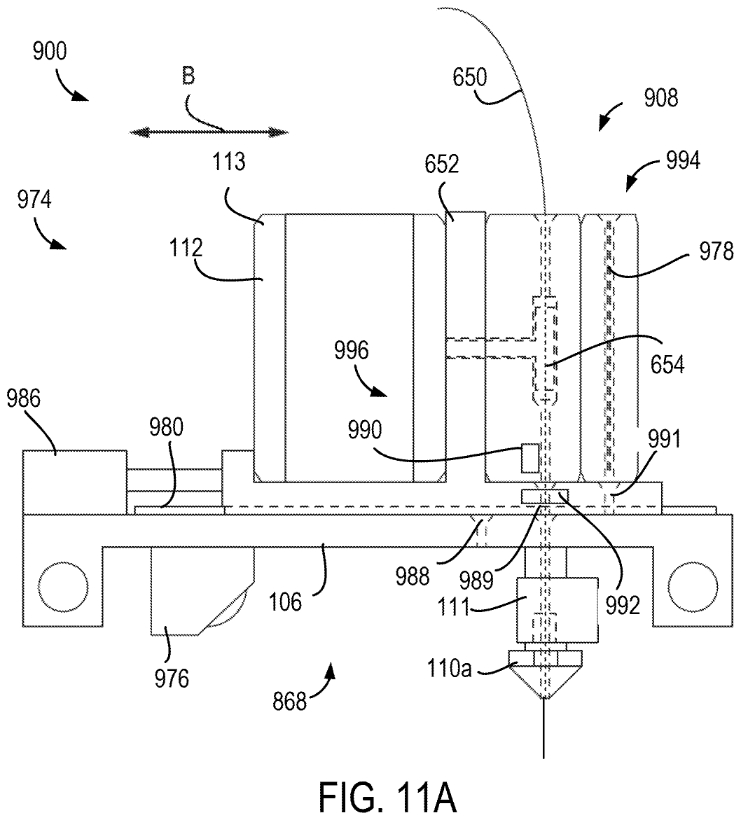

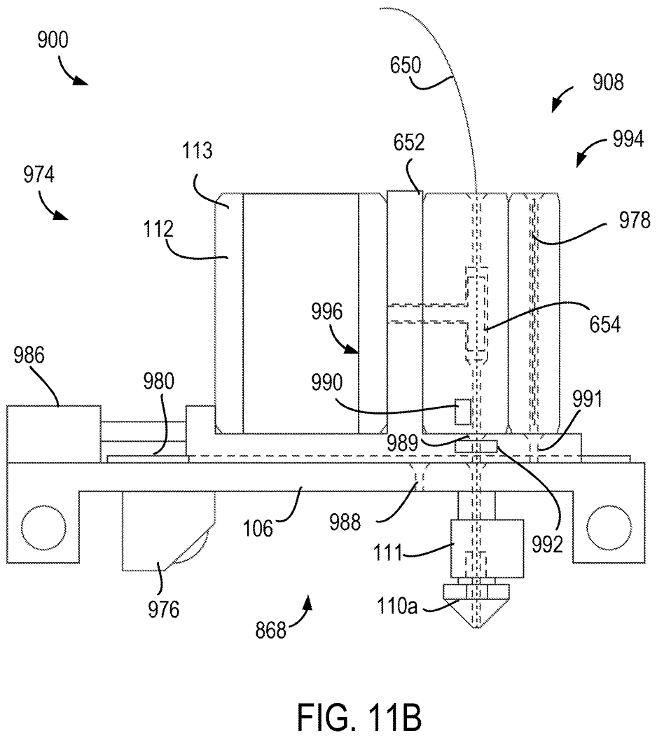

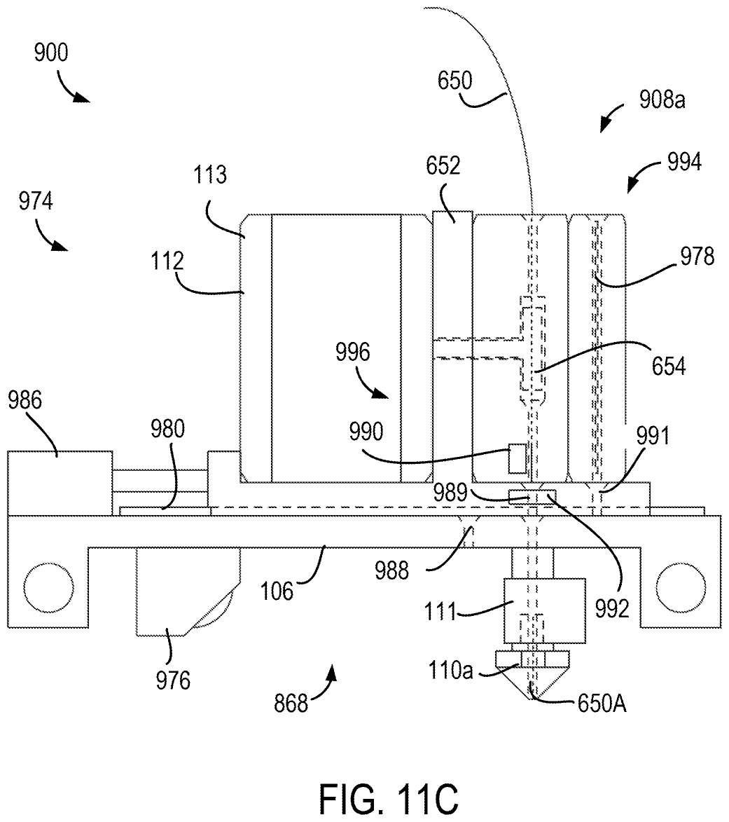

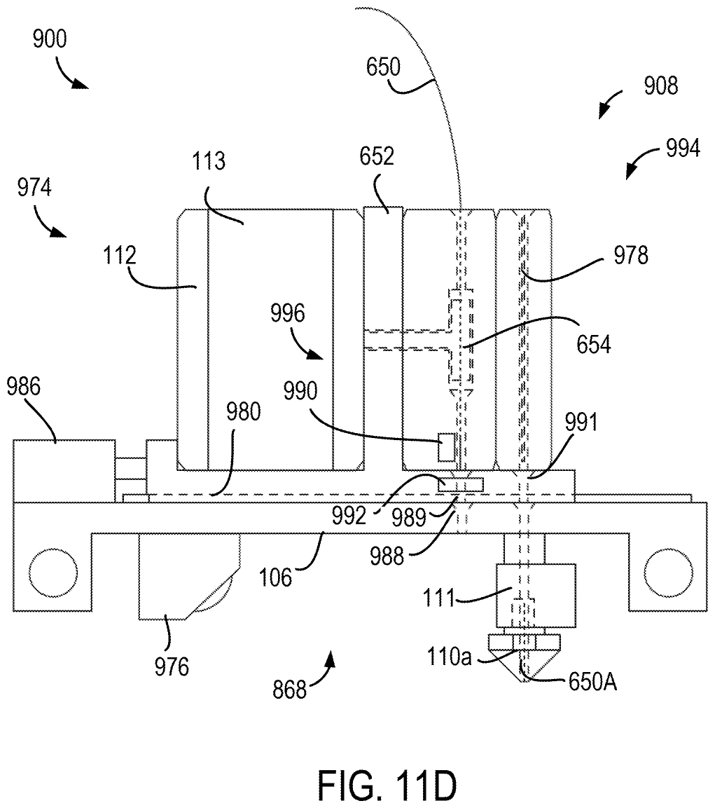

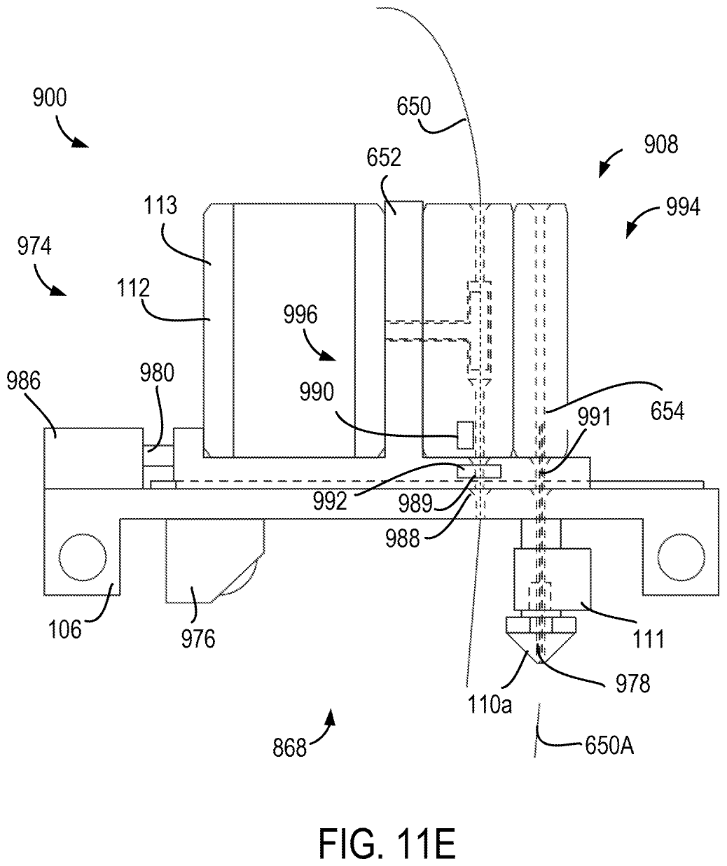

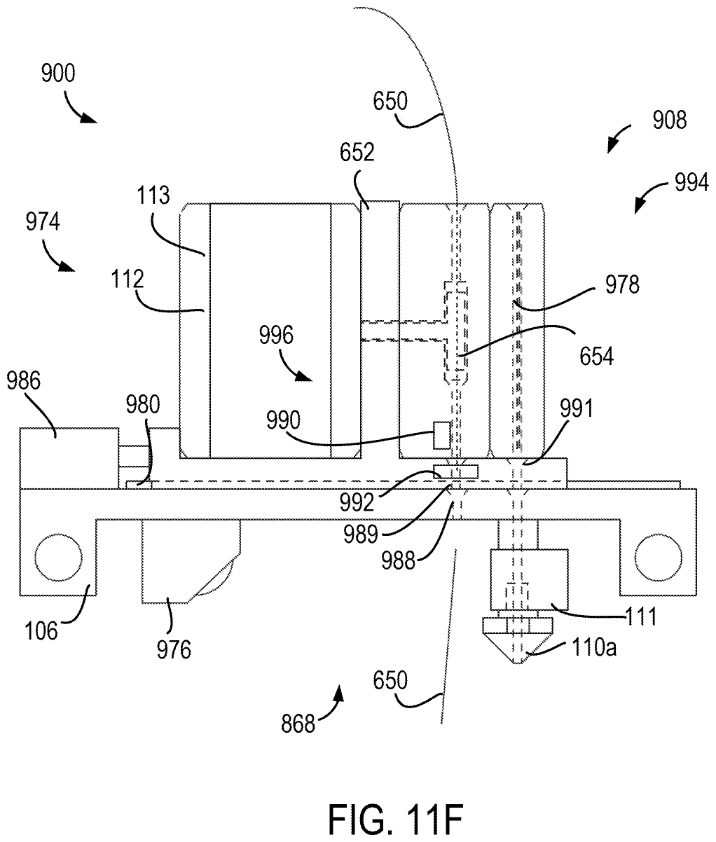

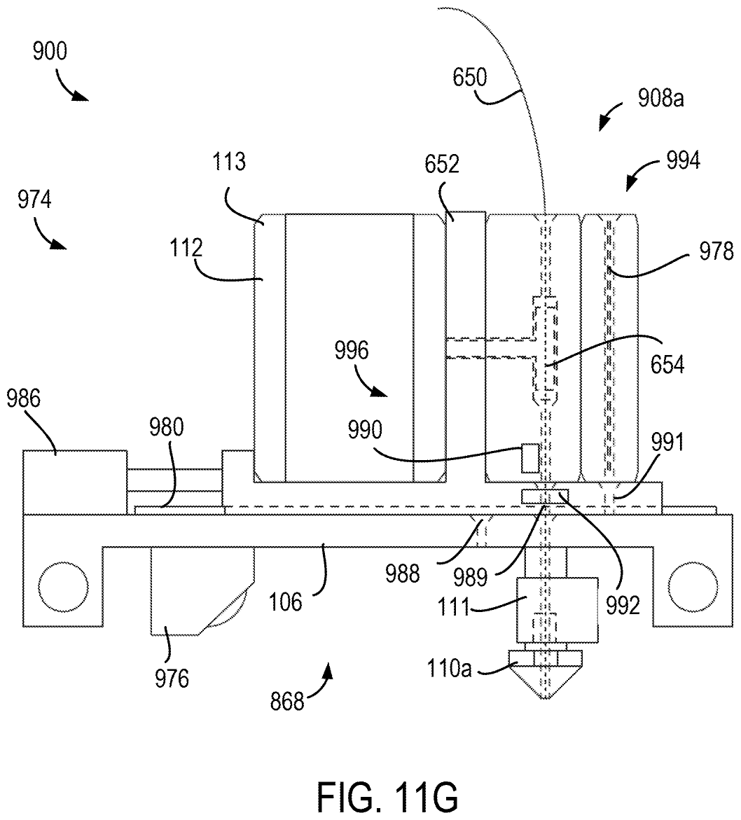

In certain embodiments, as best illustrated in FIGS. 10 and 11A-11G, the extruder assembly 108a may be configured with a clog detection and cleaning system 868 that is configured to determine when the nozzle 110a is clogged. The clog detection and cleaning system 868 may be utilized with the processing or controlling device for the printer assembly 100. As illustrated in FIG. 10, the clog detection and cleaning system 868 includes at least one sensor 870 configured to detect movement of the filament 650. In the present example, the clog detection and cleaning system 868 includes two sensors 870a and 870b. In this example, the sensor 870a is provided along the filament 650 between a filament supply 872 and the extruder assembly 108a and is configured to detect movement between the filament supply 872 and the extruder assembly 108a. The sensor 870b is provided for the filament supply 872 to detect movement of the filament supply (such as rotation, etc.). The number, type, or location of the sensors 870 should not be considered limiting on the current disclosure. During operation, as soon as the sensors 870 detect that the filament 650 is no longer moving, which may be indicative that the nozzle 110a is clogged, the sensors 870 send an alert to the processing device and the printing operation is stopped.

FIGS. 11A-G illustrate embodiments of a printer assembly 900 that includes at least one extruder assembly 908. In other examples, similar to the printer assembly 100, the printer assembly 900 may include more than one extruder assembly 908. As illustrated in FIG. 11A, the base platform 106 of the printer assembly 900 defines a filament waste passageway 988, which is configured to receive filament waste during an extruder cleaning process, as described in detail below. In examples where the heat isolation component 652 is between the filament transport casing 659/filament guide 654 and the heating element 111, the heat isolation component 652 may define a filament passageway 989. The filament passageway 989 is configured to be aligned with the nozzle 110a (see FIGS. 11A, 11B, 11C and 11G) or the filament waste passageway 988 (see FIGS. 11D-F) depending on an operation of the extruder assembly 908, as described in detail below. The heat isolation component 652 may further define a pin passageway 991, which is configured to align with the nozzle 110a (see FIGS. 11D-F) in certain operating situations, as described in detail below.

In various examples, the printer assembly 900 includes a sensor 976 that is configured to automatically monitor the printing progress during a printing operation and detect any issues that may happen on the extruder assembly 908 and/or the printed model. The number of sensors 976 should not be considered limiting on the present disclosure, as in various other examples, such as with multiple extruder assemblies 908, more than one sensor 976 may be included. In the present example, the sensor 976 is a camera configured for visual detection, although in various other examples, various other types of sensors may be utilized. In various examples, the sensor 976 is configured to detect various printing parameters or conditions, such as detecting that the material is no longer being extruded through the nozzle 110a, detecting that the colors of the model are incorrect, etc. In some cases, the sensor 976 is in communication with a processing device of the printer assembly 900 for data processing (such as image processing when the sensor 976 is the camera) and print management.

Although not illustrated, the extruder assembly 908 is similar to the extruder assembly 108a in that the extruder assembly 908 includes an actuator for moving the nozzle 110a between stowed and deployed positions. In addition to the actuator that moves the extruder assembly 908 vertically relative to the base platform 106, the extruder assembly 908 further includes a lateral actuator 986. The lateral actuator 986 is configured to move the extruder assembly 908 along the base platform 106 in the direction indicated by the arrow B. In cases where the heat isolation component 652 is included, the heat isolation component 652 may include rails 980 or other guides to aid in movement of the extruder assembly through the lateral actuator. In such cases, the base platform 106 of the extruder assembly 908 may include mating rails or guides that may be used with the rails 980 or guides of the heat isolation component 652.

Similar to the vertical actuator, the lateral actuator 986 may be various suitable components for laterally moving the extruder assembly 908, including, but not limited to, an electric magnet mechanism, a mechanical actuator, or various other suitable components. Any suitable mechanical, electrical, pneumatic, magnetic, or any other solution may be used to control the vertical positioning of the extruders. As described in detail below, the lateral actuator 986 may be utilized to move the extruder assembly 908 between a printing position (see FIGS. 11A and 11G) and a cleaning position (see FIGS. 11D-F).

The extruder assembly 908 includes an automatic cleaning system 974. The automatic cleaning system 974 includes a filament cleaning assembly 996 and a nozzle cleaning assembly 994. The filament cleaning assembly 996 includes a filament position sensor 990 and a filament cutter 992. In some cases, the filament position sensor may be adjacent to the filament 650 within the extruder body 112. The filament cutter 992 may be positioned adjacent to the filament 650 as it exits the extruder body 112. For example, the filament cutter 992 may optionally be within the base platform 106 of the extruder assembly 908, or may be at various other positions suitable for cutting the filament 650 as described in detail below. The nozzle cleaning assembly 994 includes a cleaning pin 978. In some cases, the cleaning pin 978 may be any component suitable for cleaning the internal channel of the nozzle 110a. The cleaning pin 978 is movable between a stowed position (see FIG. 11D) and a deployed position (see FIG. 11E). In various examples, the automatic cleaning system 974 may be used when the extruder assembly 908 is in the cleaning position after the sensor 976 detects an incorrect extruder function (such as clogging or incorrect printing).

The automatic cleaning system 974 is configured to perform a cleaning operation on the extruder assembly 908. Referring to FIG. 11A, prior to the cleaning operation, the filament 650 is fed through the extruder assembly 908 and out of the nozzle 110a. Referring to FIG. 11B, to start the cleaning operation, the sensor 976 may detect the incorrect extruder function. For example, a clogged nozzle 110a may be detected if no filament 650 is extruded out of the nozzle 110a. Upon detection of an incorrect extruder function, the printer assembly may position the extruder assembly 908 over an internal waste bin (not shown).

Referring to FIG. 11C, upon detection of the incorrect extruder function, the heating element 111 is configured to heat the nozzle 110a to a suitable temperature for heating and/or burning of any filament 650A clogging the nozzle 110a. In some cases, the temperature of the nozzle 110a may depend on the type of filament used. The extruder motor 113 is configured to retract the filament 650 through the filament guide 654 until the filament position sensor 990 detects that the filament channel 766 is clean or free from filament. In some cases, the correct position of the filament 650 during the cleaning operation may be above the nozzle 110a and/or within the extruder assembly 908, although it need not be.

As illustrated in FIG. 11D, the lateral actuator 986 moves the extruder assembly 908 to the cleaning position. In the cleaning position, the extruder assembly 908 is laterally positioned such that the filament 650 is aligned with the filament waste passageway 988 and the cleaning pin 978 is aligned with the nozzle 110a. Referring to FIG. 11E, once in the cleaning position, the nozzle cleaning assembly 994 and the filament cleaning assembly 996 are configured to clean the filament and nozzle, respectively. Cleaning of the nozzle 110a and filament 650 may occur concurrently or at different time periods.

As illustrated in FIG. 11F, during filament cleaning with the filament cleaning assembly 996, the extruder motor 113 advances the filament 650 by a predetermined amount into the filament waste passageway 988. After the advancement of the filament 650 into the filament waste passageway 988, the filament cutter 992 cuts the filament 650 such that a portion of the filament 650 is discarded through the filament waste passageway 988. The waste filament may be collected in a filament waste basket or other suitable collector component. The advancing and cutting of the filament 650 may ensure that new and clean filament 650 is in the extruder assembly 908 when the printing operation resumes.

As illustrated in FIG. 11E, during nozzle cleaning with the nozzle cleaning assembly 994, the cleaning pin 978 is lowered from the stowed position (see FIG. 11D) into the heated nozzle 110a to clean the internal channel of the nozzle 110a (see FIG. 11E) by ejecting the burned and/or clogged filament out of the nozzle 110a. After cleaning the internal channel of the nozzle 110a, the cleaning pin 978 is returned to its stowed position.

Upon completion of the nozzle cleaning and filament cleaning, the extruder assembly 908 is returned to the printing position (see FIG. 11G). In some examples, as the extruder assembly 908 is returned to the printing position, the nozzle 110a may brush against a cleaning lip mounted on the filament waste basket to clean any filament left on the nozzle 110a before the printing operation is resumed. In some cases, the nozzle 110a is heated up to a normal printing temperature, and a certain amount of filament is extruded into the waste bin to refill the nozzle 110a. The extruder assembly 908 may resume an already started print job or may start a new print job. If an already started print job is resumed, the sensor 768 may aid in correct repositioning of the extruder assembly 908.

The clog detection and cleaning system 868 may be used alone or in conjunction with any of the systems described herein with respect to 3D printer assemblies.

In the embodiments that include a single extruder assembly, it may not be necessary to include an actuator, spring, motor, magnet, or other actuating device to cause the nozzle 110a to lift up and away from or to deploy toward the build platform 102 or the model 104 (or the base platform 106).

### Clog Detection and Cleaning and Inkjet Printhead Systems

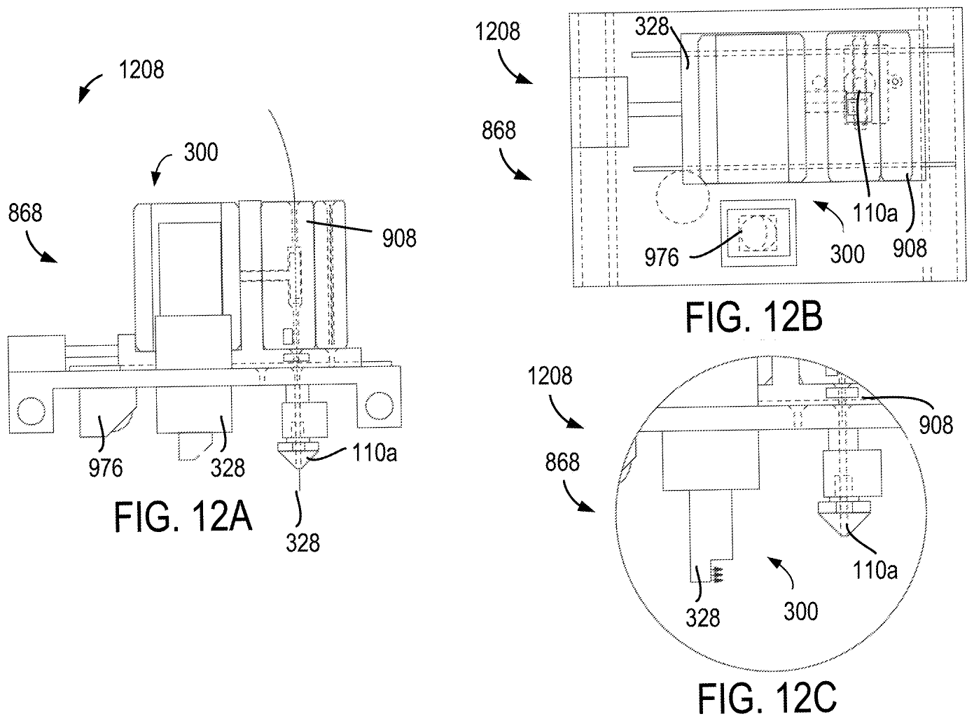

In certain embodiments, as best illustrated in FIGS. 12A-12C, the extruder assembly 1208 may be configured with the clog detection and cleaning system 868, as described above and with reference to FIGS. 10 and 11A-11G, and the inkjet printhead assembly 300, as described above and with reference to FIGS. 5-6 and 7A-7Q.

In the embodiments that include a single extruder assembly 1208, it may not be necessary to include an actuator, spring, motor, magnet, or other actuating device to cause the nozzle 110a to lift up and away from or to deploy toward the build platform 102 or the model 104 (or the base platform 106).

In further examples, the sensor 976 may be adjustable to monitor the operation of the printhead 328 and/or the operation of one or more extruder assemblies 908.

In the embodiments that include a single extruder assembly, it may not be necessary to include an actuator, spring, motor, magnet, or other actuating device to cause the nozzle 110a to lift up and away from or to deploy toward the build platform 102 or the model 104 (or the base platform 106).

### Clog Detection and Cleaning, Inkjet Printhead, and Multiple Extruder Systems

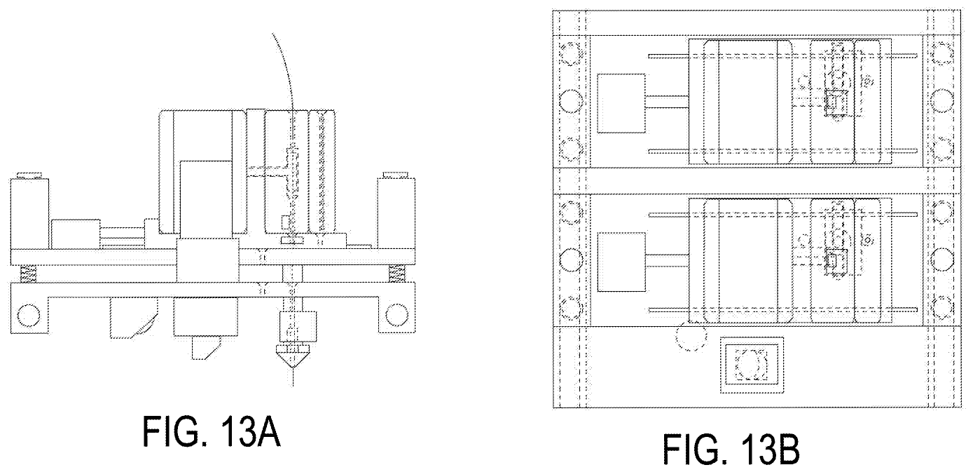

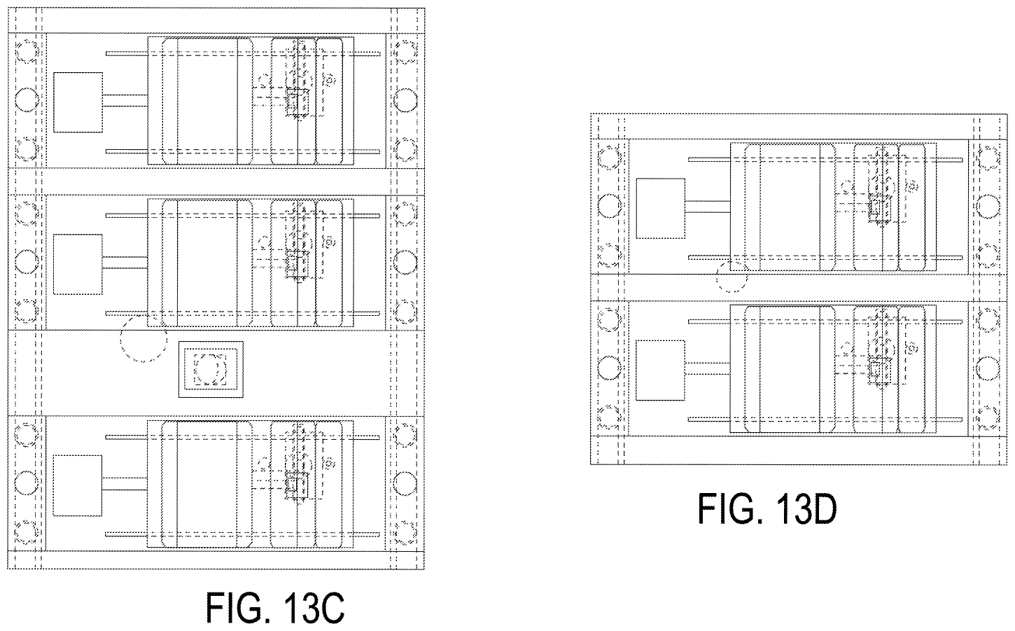

In certain embodiments, as best illustrated in FIGS. 13A-13D, the extruder assembly 1308 may be configured with the clog detection and cleaning system 868, as described above and with reference to FIGS. 10 and 11A-11G, two or more extruder assemblies 1308a, 1308b, 1308c, as described above and with reference to FIGS. 1-4, and the inkjet printhead assembly 300, as described above and with reference to FIGS. 5-6 and 7A-7Q.

Use of multiple extruder assemblies may be useful for printing with different types of materials and/or for support material removal. The extruder assemblies 1308a, 1308b, 1308c are substantially similar to the extruder assemblies 108a, 108b, 108c illustrated in FIGS. 1-3. For example, each extruder is mounted on a separate base platform 1306 where any suitable mechanical, electrical, pneumatic, magnetic, or any other solution may be used to control the vertical positioning of the extruder assemblies.

In these embodiments, the extruder assemblies 1308a, 1308b (as shown in FIG. 13B, 13D) may be used to print with two different materials (for example, one solid material, and one elastic material) or with one material while the second extruder is used to remove support material. FIG. 13B illustrates the two extruder assembly option with the inkjet printhead assembly 300, whereas FIG. 13D illustrates the two extruder assembly option without the inkjet printhead assembly 300, but includes a camera between the two extruder assemblies for nozzle and malfunction detection and continued printing after the automatic nozzle cleaning.

In further embodiments, three extruder assemblies 1308a, 1308b, 1308c (as shown in FIGS. 13C) may be used to print a solid material, print a flexible material (or another type of solid material), and remove support material from the model. As shown in FIG. 13C, the inkjet printhead assembly 300 may be positioned between two of the extruder assemblies for better weight distribution and a more compact assembly where less airspace is needed to reach all corners of the model.

In these embodiments, any suitable actuator, spring, motor, magnet, or other actuating device, as described above and with reference to FIGS. 1-4, may be included to cause the nozzle 110a of each extruder assembly 1308a, 1308b, 1308c to lift up and away from or to deploy toward the build platform 102 or the model 104 (or the base platform 106).

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

A collection of exemplary embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the invention is not limited to these example embodiments but rather encompasses all possible modifications and variations within the scope of the issued claims and their equivalents.

EC 1. A three-dimensional printer comprising: two or more extruders couplable to a base platform and movable toward a build platform to generate a three-dimensional model on the build platform; a first actuator corresponding to a first extruder of the two or more extruders and configured to move the first extruder into a deployed position for applying a layer of a material to the three-dimensional model; and a second actuator corresponding to a second extruder of the two or more extruders and configured not to move the second extruder into the deployed position during operation of the first actuator.

EC 2. The three-dimensional printer of any of the preceding or subsequent example combinations, wherein each of the two or more extruders includes a nozzle configured to heat for softening the material prior to applying the layer of the material to the three-dimensional model, wherein the first actuator is configured to move the first extruder into the deployed position in response to the nozzle heating.

EC 3. The three-dimensional printer of any of the preceding or subsequent example combinations, wherein the first actuator is configured to move the first extruder toward the build platform in response to the first extruder being selected for use to apply the layer of the material.

EC 4. The three-dimensional printer of any of the preceding or subsequent example combinations, wherein the first actuator is configured to apply a magnetic force to move the first extruder into the deployed position.

EC 5. The three-dimensional printer of any of the preceding or subsequent example combinations, wherein the first actuator includes an electric magnet configured to apply a magnetic force to the first extruder.

EC 6. The three-dimensional printer of any of the preceding or subsequent example combinations, wherein the first actuator is configured to apply a mechanical force to move the first extruder into the deployed position.

EC 7. The three-dimensional printer of any of the preceding or subsequent example combinations, wherein the first actuator includes an electric motor configured to apply a mechanical force to the first extruder.

EC 8. The three-dimensional printer of any of the preceding or subsequent example combinations, further including two or more spring assemblies corresponding to the two or more extruders and positionable to retain the two or more extruders in a stowed position.

EC 9. The three-dimensional printer of any of the preceding or subsequent example combinations, wherein the two or more spring assemblies includes a first spring assembly positionable proximate to the first extruder to apply a force to the first extruder in a stowing direction, wherein the first actuator is configured to apply an opposing force in a deploying direction that is greater than the force to the first extruder in the stowing direction.

EC 10. The three-dimensional printer of any of the preceding or subsequent example combinations, further comprising a processing device communicatively coupled to the first actuator and the second actuator, the processing device including instructions executable by the processing device for causing the first actuator to move the first extruder into the deployed position.

EC 11. The three-dimensional printer of any of the preceding or subsequent example combinations, further comprising: a screw positionable proximate to the first extruder to control a distance that the first extruder moves into the deployed position in response to the operation of the first actuator.

EC 12. The three-dimensional printer of claim 11, wherein the screw is adjustable to change the distance that the first extruder moves into the deployed position.

EC 13. A method for printing a three-dimensional model, including: positioning two or more extruders proximate to a build platform, each of the two or more extruders including a nozzle for applying a material on the build platform; applying a first force to a first extruder of the two or more extruders to move the first extruder into a deployed position for applying the material; and applying a second force to a second extruder of the two or more extruders to retain the second extruder in a stowed position.

EC 14. The method of any of the preceding or subsequent example combinations, wherein applying the first force to the first extruder includes moving the first extruder into the deployed position in response to the nozzle of the first extruder heating.

EC 15. The method of any of the preceding or subsequent example combinations, wherein applying the first force to the first extruder includes moving the first extruder into the deployed position in response to a selection of the first extruder for printing the three-dimensional model on the build platform.

EC 16. The method of any of the preceding or subsequent example combinations, wherein the first force includes a magnetic force applied by an electric magnet.

EC 17. The method of any of the preceding or subsequent example combinations, wherein the first force includes a mechanical force applied by a motor.

EC 18. The method of any of the preceding or subsequent example combinations, wherein the second force is applied in a stowing direction by one or more springs.

EC 19. The method of any of the preceding or subsequent example combinations, further including applying a third force to the first extruder in a stowing direction, wherein the first force is greater than the third force.

EC 20. The method of any of the preceding or subsequent example combinations, further including adjusting a screw to change a distance that the first extruder moves into the deployed position in response to applying the first force.

EC 21. A three-dimensional printer, comprising: a printhead assembly including: a printhead movable into a deployed position and configured to apply colored ink to a portion of a layer of a three-dimensional model printed on a build platform; and an actuator configured to move the printhead into the deployed position to apply the colored ink.

EC 22. The three-dimensional printer of any of the preceding or subsequent example combinations, wherein the printhead assembly further includes an ink cartridge positionable proximate to the printhead and containing the colored ink.

EC 23. The three-dimensional printer of any of the preceding or subsequent example combinations, wherein the colored ink includes ink having two or more different colors contained in the ink cartridge.

EC 24. The three-dimensional printer of any of the preceding or subsequent example combinations, wherein the actuator is configured to apply a magnetic force to move the printhead into the deployed position.

EC 25. The three-dimensional printer of any of the preceding or subsequent example combinations, wherein the actuator includes an electric magnet configured to apply a magnetic force to the printhead.

EC 26. The three-dimensional printer of any of the preceding or subsequent example combinations, wherein the actuator is configured to apply a mechanical force to move the printhead into the deployed position.

EC 27. The three-dimensional printer of any of the preceding or subsequent example combinations, wherein the actuator includes an electric motor configured to apply a mechanical force to the printhead.

EC 28. The three-dimensional printer of any of the preceding or subsequent example combinations, further including a spring assembly positionable proximate to the printhead to apply an opposing force to the printhead in an opposite direction of a force applied by the actuator.

EC 29. The three-dimensional printer of any of the preceding or subsequent example combinations, wherein the printhead is configured to apply the colored ink to a top portion of the layer of the three-dimensional model.

EC 30. The three-dimensional printer of any of the preceding or subsequent example combinations, wherein the printhead is configured to apply the colored ink to a side portion of the layer of the three-dimensional model.

EC 31. The three-dimensional printer of any of the preceding or subsequent example combinations, wherein the printhead is turnable 360 degrees to apply the colored ink to multiple sides of the three-dimensional model.

EC 32. The three-dimensional printer of any of the preceding or subsequent example combinations, further including a second printhead, wherein each of the printhead and the second printhead is turnable 180 degrees.

EC 33. The three-dimensional printer of any of the preceding or subsequent example combinations, further including two additional printheads, wherein each of the printhead and the two additional printheads is turnable 120 degrees.

EC 34. The three-dimensional printer of any of the preceding or subsequent example combinations, further including three additional printheads, wherein each of the printhead and the three additional printheads is turnable 90 degrees.

EC 35. The three-dimensional printer of any of the preceding or subsequent example combinations, further comprising an extruder including a nozzle configured to extrude a material for generating the layer of the three-dimensional model and positionable a first distance from the build platform, wherein the actuator is configured to move the printhead into the deployed position until the printhead is positioned at a second distance from the build platform, wherein the second distance is equal to the first distance.

EC 36. The three-dimensional printer of any of the preceding or subsequent example combinations, wherein the actuator is further configured to move the printhead into the deployed position and toward a second layer of the three-dimensional model positioned adjacent to the layer, the layer having the colored ink applied to the portion of the layer, wherein the printhead is configured to apply the colored ink to a portion of the second layer.

EC 37. A method for applying ink to a three-dimensional model, comprising: coupling an ink cartridge to a printhead, the ink cartridge having colored ink; positioning the printhead proximate to a first layer of the three-dimensional model; applying a force to the printhead to move the printhead into a deployed position; and applying the colored ink to a portion of the first layer of the three-dimensional model.

EC 38. The method of any of the preceding or subsequent example combinations, further including applying an opposing force to the printhead in an opposite direction of the force.

EC 39. The method of any of the preceding or subsequent example combinations, wherein the opposing force is applied by one or more springs.

EC 40. The method of any of the preceding or subsequent example combinations, wherein the force includes a magnetic force applied by an electric magnet.

EC 41. The method of any of the preceding or subsequent example combinations, wherein the force includes a mechanical force applied by a motor.

EC 42. The method of any of the preceding or subsequent example combinations, wherein applying the colored ink to the portion of the first layer of the three-dimensional model includes turning the printhead toward the portion of the first layer.

EC 43. The method of any of the preceding or subsequent example combinations, wherein the printhead is one of a plurality of printheads, the method further including turning each of the plurality of printheads toward a respective portion of the first layer to apply the colored ink to the respective portion of the first layer.

EC 44. The method of any of the preceding or subsequent example combinations, further including: applying a second force to the printhead to move the printhead into the deployed position and toward a second layer of the three-dimensional model positioned adjacent to the first layer, the first layer having the colored ink applied to the portion of the first layer by the printhead; and applying the colored ink to a portion of the second layer of the three-dimensional model.

EC 45. A printing assembly for a three-dimensional printer, the printing assembly including: a first printing device for applying a material to generate a three-dimensional model on a surface of a build platform; and an actuator configured to move the first printing device into a deployed position for applying the material.

EC 46. The printing assembly of any of the preceding or subsequent example combinations, wherein the first printing device includes an extruder having a nozzle configured to heat for softening the material.

EC 47. The printing assembly of any of the preceding or subsequent example combinations, wherein the actuator is configured to move the extruder into the deployed position in response to the extruder being selected for use to apply the material.

EC 48. The printing assembly of any of the preceding or subsequent example combinations, wherein the actuator is configured to move the extruder into the deployed position in response to the nozzle heating.

EC 49. The printing assembly of any of the preceding or subsequent example combinations, further including a second extruder and a second actuator, wherein the second actuator is configured not to move the second extruder into the deployed position during operation of the actuator on the extruder.

EC 50. The printing assembly of any of the preceding or subsequent example combinations, wherein the first printing device includes a printhead coupled to cartridge for containing the material, wherein the material includes colored ink.

EC 51. The printing assembly of any of the preceding or subsequent example combinations, wherein the colored ink includes ink having two or more different colors.

EC 52. The printing assembly of any of the preceding or subsequent example combinations, wherein the actuator is configured to move the printhead into the deployed position to apply the colored ink to a portion of the three-dimensional model.

EC 53. The printing assembly of any of the preceding or subsequent example combinations, wherein the actuator is configured to apply a magnetic force to move the first printing device into the deployed position.

EC 54. The printing assembly of any of the preceding or subsequent example combinations, wherein the actuator is configured to apply a mechanical force to move the first printing device into the deployed position.

EC 55. The printing assembly of any of the preceding or subsequent example combinations, further including at least one spring assembly positionable to retain the first printing device in a stowed position.

EC 56. The printing assembly of any of the preceding or subsequent example combinations, further comprising a processing device communicatively coupled to the actuator and including instructions executable by the processing device for causing the actuator to move the first printing device into the deployed position.

EC 57. The printing assembly of any of the preceding or subsequent example combinations, further comprising a second printing device for applying a second material to generate the three-dimensional model, wherein the first printing device is an extruder, wherein the material includes a plastic polymer, wherein the second printing device includes a printhead coupled to an ink cartridge containing colored ink, wherein the second material includes the colored ink, wherein the second printing device is configured to apply the colored ink on a layer of the plastic polymer.

EC 58. The printing assembly of any of the preceding or subsequent example combinations, further comprising a monitoring device positionable proximate to the first printing device for generating information regarding a position of the first printing device.

EC 59. A three-dimensional printer comprising: at least two extruder assemblies couplable to a base platform and movable between a stowed position to a deployed position; a first actuator for a first extruder assembly of the at least two extruder assemblies; and a second actuator for a second extruder assembly of the at least two extruder assemblies, wherein the second actuator is configured to retain the second extruder assembly in the stowed position when the first extruder is in the deployed position, and wherein the first extruder assembly is configured to print a printing material to generate a three-dimensional model on a build platform while in the deployed position.

EC 60. The three-dimensional printer of any of the preceding or subsequent example combinations, wherein: each of the at least two extruder assemblies includes a nozzle; each nozzle comprises a heating element configured to heat the printing material prior to applying the printing material to the three-dimensional model; and the first actuator is configured to move the first extruder assembly into the deployed position in response to the heating of the nozzle with the heating element.

EC 61. The three-dimensional printer of any of the preceding or subsequent example combinations, wherein the first actuator is configured to move the first extruder assembly toward the build platform from the stowed position in response to the first extruder assembly being selected for use to apply the printing material.

EC 62. The three-dimensional printer of any of the preceding or subsequent example combinations, wherein the first actuator is configured to apply a magnetic force to move the first extruder assembly into the deployed position.

EC 63. The three-dimensional printer of any of the preceding or subsequent example combinations, wherein the first actuator comprises an electric magnet configured to apply the magnetic force to the first extruder assembly.

EC 64. The three-dimensional printer of any of the preceding or subsequent example combinations, wherein the first actuator is configured to apply a mechanical force to move the first extruder assembly into the deployed position.

EC 65. The three-dimensional printer of any of the preceding or subsequent example combinations, wherein the first actuator comprises an electric motor configured to apply the mechanical force to the first extruder assembly.

EC 66. The three-dimensional printer of any of the preceding or subsequent example combinations, further including spring assemblies for each of the at least two extruder assemblies, wherein the spring assemblies are positionable to retain the at least two extruder assemblies in the stowed position.

EC 67. The three-dimensional printer of any of the preceding or subsequent example combinations, wherein the spring assemblies comprise a first spring assembly positioned proximate to the first extruder, wherein the first spring assembly is configured to apply a force to the first extruder in a stowing direction, and wherein the first actuator is configured to apply an opposing force in a deploying direction that is greater than the force to the first extruder assembly in the stowing direction.

EC 68. The three-dimensional printer of any of the preceding or subsequent example combinations, further comprising a controller communicatively coupled to the first actuator and the second actuator, wherein the controller comprises a memory device and a processing device, and wherein the memory device comprises instructions executable by the processing device for causing the first actuator to move the first extruder assembly into the deployed position.

EC 69. The three-dimensional printer of any of the preceding or subsequent example combinations, further comprising a stopper, wherein the stopper defines a movement distance of the first extruder assembly from the stowed position to the deployed position.

EC 70. The three-dimensional printer of any of the preceding or subsequent example combinations, wherein the stopper is adjustable such that the movement distance is a variable distance.

EC 71. A three-dimensional printer comprising: at least one extruder assembly; an inkjet printhead assembly comprising: a printhead configured to apply colored ink to a portion of a layer of a three-dimensional model printed on a build platform; and an actuation mechanism configured to move the printhead between a stowed position and a deployed position.

EC 72. The three-dimensional printer of any of the preceding or subsequent example combinations, further comprising: further comprising a camera configured to performed one or more of the following functions: detect a clogged nozzle, continue print in the location after auto cleaning of the nozzle, detect small print issues, make minor adjustments, and monitor, adjust, and improve the inkjet color print.

EC 73. The three-dimensional printer of any of the preceding or subsequent example combinations, further comprising: the at least one extruder assembly comprising a nozzle and a heating element; a filament transport casing surrounding a material filament; and a heat isolation component provided between the heating element and the filament transport casing.

EC 74. The three-dimensional printer of any of the preceding or subsequent example combinations, further comprising: the at least one extruder assembly comprising a nozzle and a heating element; a filament transport casing surrounding a material filament; and a liquid cooling system having a flow path through the filament transport casing.

EC 75. A three-dimensional printer comprising: at least one extruder assembly comprising a nozzle and a heating element; a filament transport casing surrounding a material filament; and a liquid cooling system having a flow path through the filament transport casing.

EC 76. A three-dimensional printer comprising: at least one extruder assembly comprising a nozzle and a heating element; a filament transport casing surrounding a material filament; and a heat isolation component provided between the heating element and the filament transport casing.

EC 77. A three-dimensional printer comprising: at least one extruder assembly comprising a nozzle; a clog detection and cleaning system comprising: a sensor to detect a clogged nozzle; a lateral actuator configured to move the at least one extruder assembly between a printing position and a cleaning position; and a nozzle cleaning assembly.

EC 78. The three-dimensional printer of any of the preceding or subsequent example combinations, further comprising: an inkjet printhead assembly comprising: a printhead configured to apply colored ink to a portion of a layer of a three-dimensional model printed on a build platform; and an actuation mechanism configured to move the printhead between a stowed position and a deployed position.

EC 79. The three-dimensional printer of any of the preceding or subsequent example combinations, further comprising: the at least one extruder assembly further comprising a heating element; a filament transport casing surrounding a material filament; and a heat isolation component provided between the heating element and the filament transport casing.

EC 80. The three-dimensional printer of any of the preceding or subsequent example combinations, further comprising: the at least one extruder assembly further comprising a heating element; a filament transport casing surrounding a material filament; and a liquid cooling system having a flow path through the filament transport casing.

The above-described examples are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual examples or combinations of elements or steps are intended to be supported by the present disclosure. Moreover, although specific terms are employed herein, as well as in the claims which follow, they are used only in a generic and descriptive sense, and not for the purposes of limiting the described invention, nor the claims which follow.

That which is claimed is:

1. A three-dimensional printer comprising:
at least two extruder assemblies couplable to a base platform and movable between a stowed position to a deployed position;
a first actuator for a first extruder assembly of the at least two extruder assemblies; and
a second actuator for a second extruder assembly of the at least two extruder assemblies,
wherein the second actuator is configured to retain the second extruder assembly in the stowed position when the first extruder is in the deployed position, and
wherein the first extruder assembly is configured to print a printing material to generate a three-dimensional model on a build platform while in the deployed position.

2. The three-dimensional printer of claim 1, wherein:
each of the at least two extruder assemblies includes a nozzle;
each nozzle comprises a heating element configured to heat the printing material prior to applying the printing material to the three-dimensional model; and
the first actuator is configured to move the first extruder assembly into the deployed position in response to the heating of the nozzle with the heating element.

3. The three-dimensional printer of claim 1, wherein the first actuator is configured to move the first extruder assembly toward the build platform from the stowed position in response to the first extruder assembly being selected for use to apply the printing material.

4. The three-dimensional printer of claim 1, wherein the first actuator is configured to apply a magnetic force to move the first extruder assembly into the deployed position.

5. The three-dimensional printer of claim 4, wherein the first actuator comprises an electric magnet configured to apply the magnetic force to the first extruder assembly.

6. The three-dimensional printer of claim 1, wherein the first actuator is configured to apply a mechanical force to move the first extruder assembly into the deployed position.

7. The three-dimensional printer of claim 6, wherein the first actuator comprises an electric motor configured to apply the mechanical force to the first extruder assembly.

8. The three-dimensional printer of claim 1, further including spring assemblies for each of the at least two extruder assemblies, wherein the spring assemblies are positionable to retain the at least two extruder assemblies in the stowed position.

9. The three-dimensional printer of claim 8, wherein the spring assemblies comprise a first spring assembly positioned proximate to the first extruder, wherein the first spring assembly is configured to apply a force to the first extruder in a stowing direction, and wherein the first actuator is configured to apply an opposing force in a deploying direction that is greater than the force to the first extruder assembly in the stowing direction.

10. The three-dimensional printer of claim 1, further comprising a controller communicatively coupled to the first actuator and the second actuator, wherein the controller comprises a memory device and a processing device, and wherein the memory device comprises instructions executable by the processing device for causing the first actuator to move the first extruder assembly into the deployed position.

11. The three-dimensional printer of claim 1, further comprising a stopper, wherein the stopper defines a movement distance of the first extruder assembly from the stowed position to the deployed position.

12. The three-dimensional printer of claim 11, wherein the stopper is adjustable such that the movement distance is a variable distance.

13. A three-dimensional printer comprising:
at least one extruder assembly;
an inkjet printhead assembly comprising:
a printhead configured to apply colored ink to a portion of a layer of a three-dimensional model printed on a build platform; and
an actuation mechanism configured to move the printhead between a stowed position and a deployed position.

14. The three-dimensional printer of claim 13, further comprising a camera configured to performed one or more of the following functions: detect a clogged nozzle, continue print in the location after auto cleaning of the nozzle, detect small print issues, make minor adjustments, and monitor, adjust, and improve the inkjet color print.

15. The three-dimensional printer of claim 13, further comprising:
the at least one extruder assembly comprising a nozzle and a heating element;
a filament transport casing surrounding a material filament; and
a heat isolation component provided between the heating element and the filament transport casing.

16. The three-dimensional printer of claim 13, further comprising:
the at least one extruder assembly comprising a nozzle and a heating element;
a filament transport casing surrounding a material filament; and
a liquid cooling system having a flow path through the filament transport casing.

17. A three-dimensional printer comprising:
at least one extruder assembly comprising a nozzle and a heating element;
a filament transport casing surrounding a material filament; and
a liquid cooling system having a flow path through the filament transport casing.

18. A three-dimensional printer comprising:
at least one extruder assembly comprising a nozzle and a heating element;
a filament transport casing surrounding a material filament; and
a heat isolation component provided between the heating element and the filament transport casing.

19. A three-dimensional printer comprising:
at least one extruder assembly comprising a nozzle;
a clog detection and cleaning system comprising:
a sensor to detect a clogged nozzle;
a lateral actuator configured to move the at least one extruder assembly between a printing position and a cleaning position; and
a nozzle cleaning assembly.

20. The three-dimensional printer of claim 19, further comprising:
an inkjet printhead assembly comprising:
a printhead configured to apply colored ink to a portion of a layer of a three-dimensional model printed on a build platform; and
an actuation mechanism configured to move the printhead between a stowed position and a deployed position.

21. The three-dimensional printer of claim 20, further comprising:
the at least one extruder assembly further comprising a heating element;
a filament transport casing surrounding a material filament; and
a heat isolation component provided between the heating element and the filament transport casing.

22. The three-dimensional printer of claim 20, further comprising:
the at least one extruder assembly further comprising a heating element;
a filament transport casing surrounding a material filament; and
a liquid cooling system having a flow path through the filament transport casing.

23. The three-dimensional printer of claim 20, further comprising a rotatable inkjet printhead assembly.
